(19) United States
(12) Patent Application Publication
(10) Pub. No.: US 2025/0336132 A1
(43) Pub. Date: Oct. 30, 2025

(54) VIDEO GENERATING METHOD, APPARATUS AND STORAGE MEDIUM

(71) Applicant: Samsung Electronics Co., Ltd., Suwon-si (KR)

(72) Inventors: Lanlin TANG, Nanjing (CN); Jiang YU, Nanjing (CN); Hanxu BU, Nanjing (CN); Jie CHEN, Nanjing (CN); Longhai WU, Nanjing (CN); Lin DING, Nanjing (CN); Youxin CHEN, Nanjing (CN)

(21) Appl. No.: 19/068,627

(22) Filed: Mar. 3, 2025

Related U.S. Application Data
(63) Continuation of application No. PCT/KR2025/001641, filed on Feb. 4, 2025.

(30) Foreign Application Priority Data
Apr. 24, 2024 (CN) 202410501386.8

(51) Int. Cl. G06T 13/00; A63B 71/06; G06T 7/20; G06T 7/60; G06T 7/70; G06V 20/64; G06V 40/10; G11B 27/036

(52) U.S. Cl. CPC G06T 13/00; G06T 7/20; G06T 7/60; G06T 7/70; G06V 20/64; G06V 40/103; G11B 27/036; A63B 71/0622; A63B 2071/0694; G06T 2207/20084; G06T 2207/30196; G06T 2207/30241

(57) ABSTRACT

The disclosure provides a method and apparatus for video generation and a storage medium, and the method includes: collecting user body information and space environment information and generating a space environment image; determining a first subspace required for a next action of the user according to the user body information, the space environment information and standard action information; generating action prompt information according to the user body information, the first subspace and the standard action information; and generating a video corresponding to the action prompt information according to the space environment image, a video key frame corresponding to the standard action information and the action prompt information. The next action of the user is determined considering factors of user body conditions and actual space environment, thus the generated new video can avoid a collision between the user and the space, and no abruptness sense will be brought out, thus the user experience when following the video content is improved.

### CROSS-REFERENCE TO RELATED APPLICATIONS

This application is a continuation of International Application No. PCT/KR2025/001641 designating the United States, filed on Feb. 4, 2025, in the Korean Intellectual Property Receiving Office and claiming priority to Chinese Patent Application No. 202410501386.8, filed on Apr. 24, 2024, in the Chinese Patent Office, the disclosures of each of which are incorporated by reference herein in their entireties.

### BACKGROUND

### Field

The disclosure relates to the field of computer vision, and for example, to a method for video generation, an apparatus for video generation, and a storage medium.

### Description of Related Art

Existing video products typically do not consider the space environment of users on-site, as users passively accept the existing video content. When users follow video content, they may be limited by their space environment. For example, when a user follows a fitness video, some fitness actions may not be able to be completed in his space environment. Some video products may consider the space environment of users on-site, but mostly provide simple reminders or warnings to users, or apply simple processing such as distorting or moving the displayed video pictures to help users avoid collision with their space environment. For example, in certain virtual reality scenarios like virtual reality (VR) games, video pictures can be processed to help users avoid collision with their environment.

Completely ignoring the space environment may directly lead to collision between the user and the space. By reminding users or making simple processing to the video pictures, users may experience an abruptness sense during the video content experience, leading to a poor user experience.

### SUMMARY

Embodiments of the disclosure provide a method for video generation, which can address collision and abruptness sense caused by unconsidered space environment or just simple reminders, and making video content and space environment harmonious and improving the user experience.

According to an example embodiment, a method for video generation includes:
collecting user body information and space environment information and generating a space environment image, the user body information including feature information describing occupation of a three-dimensional space by each body part of the user, and the space environment information including feature information describing a space environment and occupation of the three-dimensional space by an object in the space environment;
generating action prompt information according to the user body information, the space environment information and standard action information, the standard action information including feature information about a standard action that is not subject to the user body information and the space environment information, and the action prompt information including description information about a next action of the user; and
generating a video corresponding to the action prompt information according to the space environment image, a video key frame corresponding to the standard action information and the action prompt information.

Additionally, between the process of collecting the user body information and the space environment information and generating the space environment image and the process of generating the action prompt information according to the user body information, the space environment information and standard action information, the method further includes:
determining a first subspace required for the next action of the user according to the user body information, the space environment information, and the standard action information; and
the generating the action prompt information according to the user body information, the space environment information and standard action information includes: generating the action prompt information according to the user body information, the first subspace, and the standard action information.

Additionally, the determining the first subspace required for the next action of the user according to the user body information, the space environment information and the standard action information includes:
calculating, according to the user body information and the standard action information, the amount of space required by the user to perform the standard action;
dividing, according to the amount of space required by the user, the space environment to obtain candidate subspaces; and
selecting, according to a first specified condition, a subspace satisfying the first specified condition from the candidate subspaces as the first subspace.

Additionally, the generating the action prompt information according to the user body information, the first subspace, and the standard action information includes:
determining a spatial position relationship between respective related body parts of the user and the first subspace according to the user body information, the first subspace, and the standard action information;
combining the respective related body parts of the user and the first subspace to generate candidate actions;
selecting a target action from the candidate actions according to a second specified condition, the target action being the next action to be completed by the user in the first subspace; and
generating the action prompt information according to the spatial position relationship between the respective related body parts of the user and the first subspace in the target action.

Additionally, in response to the body part of the user needing assistance of an object in the space environment:
the first subspace is space environment where the first subspace is located and includes a space of the object providing the assistance;
the determining the spatial position relationship between respective related body parts of the user and the first subspace according to the user body information, the first subspace, and the standard action information includes: determining a spatial position relationship between the respective related body parts of the user and the object providing the assistance in the first subspace in response to predicting that the user performs the standard action in the first subspace; and
the generating the action prompt information according to the spatial position relationship between the respective related body parts of the user and the first subspace in the target action includes: generating the action prompt information according to the spatial position relationship between the respective related body parts of the user and an object in the first subspace in the target action.

Additionally, in response to the body part of the user needing to avoid an object in the space environment:
the first subspace includes a space environment where the first subspace is located and does not include a space of the object to be avoided;
the determining the spatial position relationship between respective related body parts of the user and the first subspace according to the user body information, the first subspace, and the standard action information includes: determining a spatial position of the respective related body parts of the user in the first subspace in response to predicting that the user performs the standard action in the first subspace; and
the generating the action prompt information according to the spatial position relationship between the respective related body parts of the user and the first subspace in the target action includes: generating the action prompt information according to the spatial position of the respective related body parts of the user in the first subspace in the target action.

Additionally, the amount of the first subspaces is N, wherein Nis a natural number greater than one;
the generating the action prompt information according to the user body information, the first subspace, and the standard action information includes: generating, according to the user body information, the first subspace, and the standard action information, N pieces of action prompt information with different difficulty degrees for N first subspaces,
the video corresponding to the action prompt information including videos respectively corresponding to the N pieces of action prompt information with different difficulty degrees; and
after the process of generating the video corresponding to the action prompt information according to the space environment image, the video key frame corresponding to the standard action information and the action prompt information, the method further includes:
recommending one of the videos respectively corresponding to the N pieces of action prompt information with different difficulty degrees to the user according to acquired user body conditions, where the user body conditions are determined by the user body information and previously acquired historical user operation information.

Additionally, the method further includes: collecting movable object information in the space environment, where the movable object information includes feature information describing occupation of the three-dimensional space by the movable object;
calculating, in response to the movable object information in the space environment being collected, a movement trajectory of the user performing the standard action, and calculating a movement trajectory of the movable object; and
determining whether the movement trajectory of the user performing the standard action overlaps with the movement trajectory of the movable object, and deleting, in response to there being the overlap, a candidate subspace corresponding to the overlap when selecting a subspace satisfying the first preset condition.

Additionally, the generating the video corresponding to the action prompt information according to the space environment image, the video key frame corresponding to the standard action information and the action prompt information includes:
calculating a spatial attentional feature according to the space environment image;
calculating a temporal attentional feature according to a video key frame
corresponding to the standard action; and
inputting the spatial attentional feature, the temporal attentional feature, and the action prompt information into a trained deep learning network model, and generating the video corresponding to the action prompt information according to the space environment image and the video key frame corresponding to the standard action.

Additionally, calculating, in response to calculating a spatial attentional feature according to the space environment image, the spatial attentional feature using a first parameter feature; calculating, in response to calculating a temporal attentional feature according to a video key frame corresponding to the standard action, the temporal attentional feature using the first parameter feature, whereby calculations of the spatial attentional feature and the temporal attentional feature are feature sharing.

Embodiments of the disclosure provide an apparatus for video generation, which can address collision and abruptness sense caused by not considering the space environment or simple reminders, and provides video content and the space environment harmonious and improving the user experience.

According to an example embodiment, an apparatus for video generation includes:
a collecting module comprising circuitry, configured to collect user body information and space environment information and generate a space environment image, the user body information including feature information describing occupation of a three-dimensional space by each body part of the user, and the space environment information including feature information describing a space environment and occupation of the three-dimensional space by an object in the space environment;
an action prompt information determining module comprising circuitry, configured to generate action prompt information according to the user body information, the space environment information and standard action information, the standard action information including feature information about a standard action that is not subject to the user body information and the space environment information and the action prompt information being description information about a next action of the user; and
a video generating module comprising circuitry, configured to generate a video corresponding to the action prompt information according to the space environment image, a video key frame corresponding to the standard action information and the action prompt information.

The apparatus further includes:
a space determining module comprising circuitry, configured to determine a first subspace required for the next action of the user according to the user body information, the space environment information, and the standard action information; and
the generating the action prompt information according to the user body information, the space environment information and standard action information by the action prompt information determining module includes: generating the action prompt information according to the user body information, the first subspace, and the standard action information.

Additionally, the space determining module includes:
a user required space calculating module comprising circuitry, configured to calculate, according to the user body information and the standard action information, the amount of space required by the user to perform the standard action;
a candidate subspace determining module comprising circuitry, configured to divide, according to the amount of space required by the user, the space environment to obtain candidate subspaces; and
a first subspace determining module comprising circuitry, configured to select, according to a first preset condition, a subspace satisfying the first preset condition from the candidate subspaces as the first subspace.

Additionally, the action prompt information determining module includes:
a spatial position relationship determining module comprising circuitry, configured to determine a spatial position relationship between respective related body parts of the user and the first subspace according to the user body information, the first subspace, and the standard action information;
a candidate action determining module comprising circuitry, configured to combine the respective related body parts of the user and the first subspace to generate candidate actions;
a target action determining module comprising circuitry, configured to select a target action from the candidate actions according to a second preset condition, where the target action is the next action to be completed by the user in the first subspace; and
a description information generating module comprising circuitry, configured to generate the action prompt information according to the spatial position relationship between the respective related body parts of the user and the first subspace in the target action.

Additionally, the video generating module includes: a spatial attentional feature calculation module comprising circuitry, configured to calculate a spatial attentional feature according to the space environment image;
a temporal attentional feature calculation module comprising circuitry, configured to calculate a temporal attentional feature according to a video key frame corresponding to the standard action; and
a model calculation module comprising circuitry, configured to input the spatial attentional feature, the temporal attentional feature, and the action prompt information into a trained deep learning network model, and generate the video corresponding to the action prompt information according to the space environment image and the video key frame corresponding to the standard action.

Embodiments of the disclosure provide a non-transitory computer-readable storage medium, which can address the collision and abruptness sense caused by not considering the space environment or simple reminders, and provide video content and the space environment harmonious and improving the user experience.

A non-transitory computer-readable storage medium stores computer instructions which, when executed by a processor, cause the processor to implement steps of the method for video generation according to any of the above.

Embodiments of the disclosure provide an electronic device for video generation, which can address the collision and abruptness caused by not considering the space environment or simple reminders, and make video content and the space environment harmonious and improving user experience.

An electronic device for video generation, and the electronic device includes:
at least one processor, comprising processing circuitry; and
a memory, configured to store processor-executable instructions,
at least one processor, individually and/or collectively, configured to read the executable instructions from the memory and execute the instructions to implement the method for video generation according to any of the above.

For an abruptness sense caused by not completely considering the space environment or simply reminding the user, embodiments of the present application disclose collecting user body information and space environment information and analyzing standard action information and determining the next action of the user under the consideration of the factors of user body conditions and actual space environment, to generate a new video which is more in line with the user body condition and space environment. The generated new video can avoid the collision between the user and the space, and is not a simple reminder but is integrated into the original video, without introducing an abruptness sense, thus enhancing the user experience of following the video content.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a flowchart illustrating an example method for video generation according to various embodiments;

FIG. 2 is a flowchart illustrating an example method for determining a first subspace according to various embodiments;

FIG. 3 is a flowchart illustrating an example method for generating action prompt information according to various embodiments;

FIG. 4 is a flowchart illustrating an example method for video generation corresponding to action prompt information according to various embodiments;

FIG. 5 is a block diagram illustrating example computing of a spatial attentional feature of a space environment image according to various embodiments;

FIG. 6 is a diagram illustrating example computing of a spatial attentional feature of a video key frame image according to various embodiments;

FIG. 7 is a diagram illustrating an example scenario according to various embodiments;

FIG. 8 is a flowchart illustrating an example method for video generation according to various embodiments;

FIG. 9 is a diagram an example scenario according to various embodiments;

FIG. 10 is a diagram illustrating an example scenario according to various embodiments;

FIG. 11 is a diagram illustrating an example scenario according to various embodiments;

FIG. 12 is a block diagram illustrating an example configuration of an apparatus according to various embodiments;

FIG. 13 is a block diagram illustrating an example configuration of a space determining module according to various embodiments;

FIG. 14 is a block diagram illustrating an example configuration of an action prompt information determining module according to various embodiments;

FIG. 15 is a block diagram illustrating an example configuration a video generating module according to various embodiments; and

FIG. 16 is a block diagram illustrating an example configuration of an electronic device according to various embodiments.

### DETAILED DESCRIPTION

Various example embodiments of the disclosure will be clearly and completely described in combination with the drawings of the present application. The various example embodiments described are not limited. Based on the various example embodiments in the present application, various embodiments may be apparent to those of ordinary skill in the art.

The terms “first”, “second”, “third”, “fourth”, and the like in the disclosure, if present, are used for distinguishing between similar objects and not necessarily for describing a specific sequential or chronological order. The data used in this way may be interchanged in appropriate cases so that the various embodiments described herein, for example, may be implemented in order other than those illustrated or described here. Furthermore, the terms “include” and “have”, as well as any variations thereof, are intended to cover a non-exclusive inclusion. For example, a process, method, system, product, or device that includes a list of steps or units is not necessarily limited to those steps or units expressly listed. Still, it may include other steps or units not expressly listed or inherent to such process, method, product, or device.

The disclosure will be described in greater detail with reference to various example embodiments. The following embodiments may be combined, and the same or similar concepts or processes may not be described in detail in various embodiments.

With respect to the collision between the user and the space environment and the abruptness sense caused by just simply reminders to the user in the prior art, various embodiments of the disclosure may provide a method for video generation, through collecting user body information and on-site space environment information of the user, analyzing the relationship between the user body and the space environment, and integrating the user body and the space environment, a new video more in line with the user and the on-site environment is generated, thus the user experience of following the video content is improved.

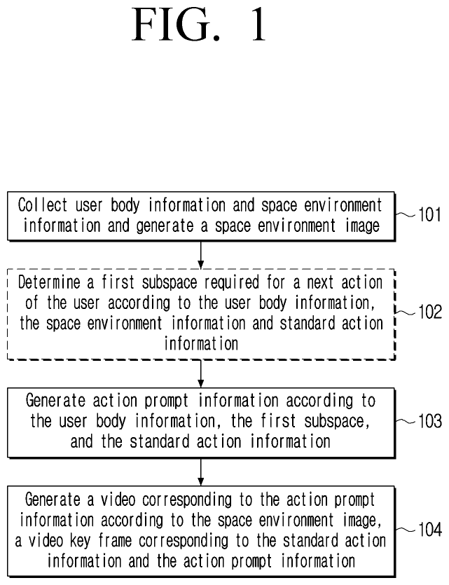

FIG. 1 is a flowchart illustrating an example method for video generation according to various embodiments. The method may generate a video in advance and integrate it into an original video watched by the user, or may generate a video and integrate it in real-time according to a practical situation while the user watching the original video. As shown in FIG. 1, the method includes:

Step 101: Collect user body information and space environment information and generate a space environment image, where the user body information includes feature information describing occupation of a three-dimensional space by each body part of the user, and the space environment information includes feature information describing space environment and occupation of the three-dimensional space by an object in the space environment.

A collection device, such as a three-dimensional camera, may be installed in advance in a space environment of the user for collecting the user body information and the space environment information and the collected data may be three-dimensional data or point cloud data. The user body information includes feature information describing occupation of a three-dimensional space by each body part of the user, and may include but is not limited to a human body height and a human body proportion. Bone detection and bone point detection as well as bone length analysis to may be further performed, to determine the size of each body part. The space environment information includes feature information describing the space environment and occupation of the three-dimensional space by an object in the space environment and may include but is not limited to length, width, and height describing the space environment, length, width, and height describing the object. It is also possible to further detect and analyze attribute information such as the name of the object, the material of the object, and the softness and hardness of the object. When collecting indoor space environment information, an embodiment regards the floor and the wall as the “space environment” itself and other objects as the “objects in the space environment”. When collecting outdoor space environment information, an embodiment regards the ground as the “space environment” itself and other objects as “objects in the space environment” for facilitating the description. The feature information of occupation of the three-dimensional space can be represented by the dimensions of length, width, and height thereof using three-dimensional coordinates. In practical applications, prior art techniques can be used to realizing detecting and analyzing the user body information and the space environment information, such as image segmentation and depth estimation methods, which are not listed here one by one.

In addition, this step may also generate a two-dimensional space environment image for subsequent video generation. The two-dimensional space environment image may be generated through mapping based on the collected three-dimensional data or may be generated directly by a two-dimensional camera, without limitation.

Step 102: Determine a first subspace required for a next action of the user according to the user body information, the space environment information and standard action information, the standard action information may include, for example, feature information about a standard action that is not subject to the user body information and the space environment information.

In the prior art, the video content is generated in advance, and the user using the video content and the space environment cannot be known in advance, therefore the demonstration action in the video content is a standard action and is subject to the user body information and the space environment information. However, in practical applications, different users have different body conditions, that is, they have different height, different gender features, and different health conditions; different space environments have different conditions, that is, they may be spacious or narrow, and have different object arrangements. In this case, if the user is forced to perform the standard action in the video according to the prior art, the user's experience is inevitably affected. The standard action information described in various embodiments may refer, for example, to the feature information about a standard action that is not subject to the user body information and the space environment information, but may correspond to a visually displayable animated action itself (such as an action performed by a real person or an animated person), or may correspond to an abstract action without a human-shaped video display (such as an action guided with the assistance of arrow, symbol, text, sound, or a certain part of the body).

Regardless of the form of the standard action, the actual space environment required for the user to perform the standard action includes the first subspace described herein. Since the user body information and the space environment information have already been obtained in step 101, the first subspace required for the user can be calculated. Depending on different body conditions of different users and different the conditions of different space environments, the determined first subspaces are usually different. The same user may perform standard actions at different positions in the same space environment, and therefore a plurality of different first subspaces may also be determined, which may be specifically selected according to the requirement of the user. In practical application, this step may also be omitted if the position and size of the first subspace are fixed.

Step 103: Generate action prompt information according to the user body information, the first subspace, and the standard action information, where the action prompt information includes description information about the next action of the user.

Once the first subspace is determined, the user may perform the next action in the first subspace. Since the standard action is an action that is not subject to the user body information and the space environment information, the next action performed by the user may be different from the standard action considering the actual user body information and the space environment information. Depending on the requirement of the user, the next action may be completed with the assistance of an object in the space environment or by staying away from an object in the space environment. To meet the requirement of the user, this step generates action prompt information, and the next action may be completed with the assistance of the object in the space environment or by avoiding the object in the space environment. In practical applications, if the above step 102 is omitted, the process of generating the action prompt information according to the user body information, the space environment information and standard action information may be changed to: generating the action prompt information according to the user body information, the first subspace, and the standard action information.

Step 104: Generate a video corresponding to the action prompt information according to the space environment image, a video key frame corresponding to the standard action information and the action prompt information.

To guide the user to complete the next action better, this step generates a video corresponding to the action prompt information. The video corresponding to the action prompt information described herein may be a visually displayable animated action itself (such as an action performed by a real person or animated person), or an abstract action without a human-shaped video display (such as an action guided by an arrow, symbol, text, sound, or part of the body). The video corresponding to the action prompt information described herein is the next action that the user actually needs to perform, which may be different from the standard action prepared in advance. For example, if the user performs the next action according to the video in this step, the action may be more compatible with the user body condition and the actual space environment. Further, since the generated new video may be integrated into the original video content, an abruptness sense is avoided, and the experience is improved.

As previously described, various embodiments may generate a video in advance and integrate it into the original video watched by the user or may generate and integrate a video in real-time according to a practical situation while the user watching the original video. In various scenarios where the video is generated and integrated into the original video in advance, key frames of the video generated in step 104 may be inserted into the original video to replace the relevant key frames to generate a complete video for the user. In other scenarios where the video is generated and integrated into the original video in real-time, key frames of the video generated in step 104 may be integrated into the relevant key frames in the original video or cover the relevant key frames in the original video to generate a complete video for the user. How to insert, replace, integrate, or cover the relevant key frames in the video may be implemented using prior art techniques and may not be described in detail here.

Various embodiments may acquire user body information and space environment information and analyze the standard action information, determine the next action of the user with the consideration of the factors of the user body condition and the actual space environment, and generate a new video which is more compatible with the user body condition and the space environment. The generated new video may avoid the collision between the user and the space, and does not just provide simple reminders, which will not introduce an abruptness sense, thus the user experience when following the video content is improved.

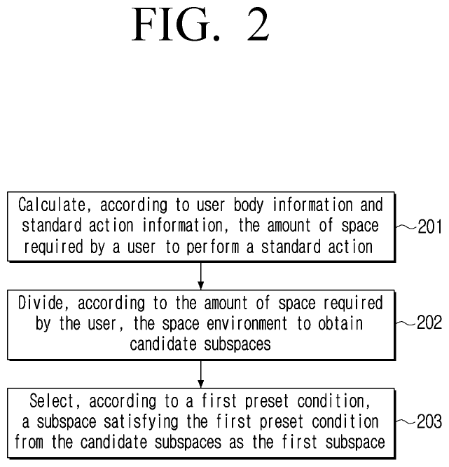

In various embodiments, step 102 may determine the first subspace according to the method described in detail below with reference to FIG. 2.

FIG. 2 is a flowchart illustrating an example method for determining a first subspace according to various embodiments. As shown in FIG. 2, the method includes:

Step 201: Calculate, according to user body information and standard action information, the amount of space required by a user to perform a standard action.

Due to the different body conditions of different users, some users are strong and need more space to complete the standard action, while some users are thin and need less space to complete the standard action. To select a suitable space, this step calculates the amount of space required by the user. Example 1: It is assumed that the user body information includes the human body height, the human body proportion, and the size of each body part, with two-arm lateral raised while standing, the height of the user, the two-arm lateral raise width, and the thickness from the front side to the rear side of the user body may be taken as the amount of space required by the user. A certain user A has a height of 1.8 meters, a width of 1.75 meters for lateral raise, and a thickness of 0.4 meters from the front side to the rear side of the body, the amount of space required to complete the two-arm lateral raise is 1.8 meters*1.75 meters*0.4 meters.

Step 202: Divide, according to the amount of space required by the user, the space environment to obtain candidate subspaces.

Generally, the space environment will be larger than the amount of space required by the user to complete a certain action, and the whole space environment may be divided into several small spaces in advance, namely, the candidate subspaces in this step. Taking Example 1 above as an example, assuming that a certain space environment is 5 meters (length)*5 meters (width)*3 meters (height), the space environment may be divided into 35 candidate subspaces in a way that the user stands on the ground. Of course, the space occupied by the action may also be expanded in practical applications as a division basis, and the number of candidate subspaces divided from the space environment will be smaller. The specific division manner may be determined according to a practical situation, and will not be described in detail herein.

Step 203: Select, according to a first preset (e.g., specified) condition, a subspace satisfying the first preset condition from the candidate subspaces as the first subspace.

After the whole space environment is divided into several small candidate subspaces, it may be necessary to select a suitable subspace from the several candidate subspaces as the first subspace. A selecting condition may be set according to a practical situation. For example, a user may wish for the assistance of an object in the space environment, and whether an object is contained may be taken as a selecting condition, to reserve a candidate subspace containing the object providing the assistance, while remove other candidate subspaces; the user may wish to avoid an object in the space environment, and whether an object is contained may also be taken as a selecting condition to remove the space containing the object to be avoided while retaining other candidate subspaces. Examples of how to set the first preset condition are listed, which may be flexibly set according to a practical situation in practical applications, and will not be illustrated one by one herein. In summary, this step may select a first subspace from the candidate subspaces according to the first preset condition, and the number of the selected first subspace may be one or more.

The method according to various embodiments describes a method of how to determine a first subspace, with which a first subspace satisfying the first preset condition may be selected from the space environment, whereby the space environment may be used more flexibly. In practical applications, a certain subspace may also be fixed as the first subspace, and the above steps 201 to 203 may be omitted in this case.

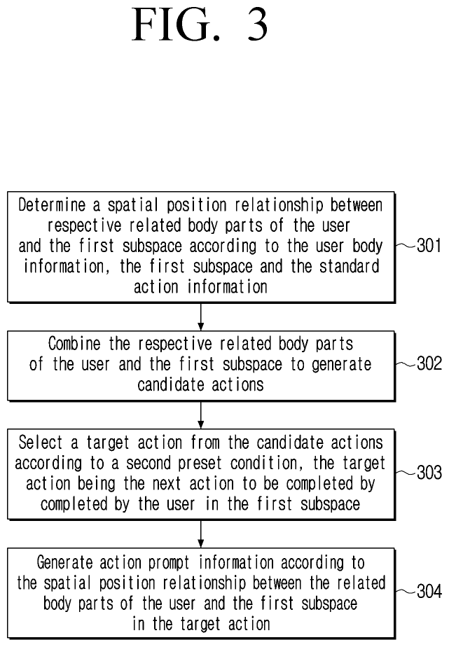

In various embodiments, step 103 may generate action prompt information according to the method illustrated in detail below with reference to FIG. 3.

FIG. 3 is a flowchart illustrating an example method for generating action prompt information according to various embodiments. As shown in FIG. 3, the method includes:

Step 301: Determine a spatial position relationship between respective related body parts of the user and the first subspace according to the user body information, the first subspace and the standard action information.

Depending on different body conditions of each user and different space environments of each user, the standard action is not necessarily applicable to all users. For example, the user body condition is weak, hoping to lower the difficulty of the standard action; or, the user body condition is very strong, hoping to increase the difficulty of the standard action; or the user may wish for the assistance of an object in the space environment; still alternatively, the user may wish to avoid an object in the space environment. Therefore, to adapt to the requirement of users, this step may determine the spatial position relationship between respective related body parts of the user and the first subspace. The respective related body part of the user refers to the body part related to the standard action, for example, the body part related to a lateral raise action is the arms. The spatial position relationship refers to a specific position of the respective related body parts of the user in the first subspace. The first subspace may be understood as a subset of the space environment and represented by feature information describing a part of the space environment and occupation of the three-dimensional space by an object in the part of the space environment. The spatial position relationship between the respective related body parts of the user and the first subspace may describe a position relationship between the respective related body parts of the user and the space environment of the first subspace or may describe a position relationship between the respective related body parts of the user and the object in the first subspace. For example, the “hands” of the user being “on” the “floor” describes the position relationship between the respective related body parts of the user and the space environment of the first subspace. For another example, the “hands” of the user being “on” the “tea table” describes the position relationship between the respective related body parts of the user and the object in the first subspace. Examples of spatial position relationships are set forth herein for ease of understanding only, and other expressions that facilitate computer operation and implementation may be used in practical applications.

Step 302: Combine the respective related body parts of the user and the first subspace to generate candidate actions.

As described above, there may be a plurality of first subspaces divided out, that is, the user may perform a standard action in a plurality of different first subspaces. Further, to accurately describe the action, this step may also consider how the respective related body parts of the user and the first subspace are combined. The term “combine” as described herein may be understood as how the respective related body parts of the user is “in contact” with the first subspace. Similar to step 301 described above, the combination of the respective related body parts of the user and the first subspace may be described as a combination of the respective related body parts of the user and the space environment of the first subspace, or as a combination of the respective related body parts of the user and the object in the first subspace. For example, the “hands” of the user “pressing” “on” the “floor” describes a combination of the respective related body parts of the user and the space environment of the first subspace. For another example, the “hands” of the user “pressing” “on” the “tea table” describes a combination of the respective related body parts of the user and the object in the first subspace. It is assumed that the user may perform a certain action in first subspace A by “hands of the user pressing on the floor” or in first subspace B by “hands of the user pressing on the tea table”. That is, a plurality of candidate actions may be generated by combining the respective related body parts of the user with a plurality of different first subspaces. Some of these candidate actions may not meet the requirement of the user and may be further filtered through step 303 described below.

In addition, in practical applications, it is also possible to adjust the standard actions when combining the respective related body parts of the user with the first subspace. For example, when the hands of the user press on the floor to complete a plank, the whole body is substantially parallel to the floor, and when the hands of the user press on the tea table to complete the plank, the whole body is tilted with the head higher than the legs. For another example, the user may also complete the plank action in first subspace C by the “hands” of the user “pressing” on the “floor” and the “knees” “kneeling” on the “sofa”, the whole body is also tilted while the legs are higher than the head. In practical applications, the way of adjusting the standard action may be recorded in advance, and the standard action may be adjusted flexibly according to the actual situation. Regardless of whether the action performed in the first subspace differs from the standard action, it is a candidate action generated by combining the respective related body parts of the user and the first subspace in an embodiment.

Step 303: Select a target action from the candidate actions according to a second preset condition, where the target action is the next action to be completed by the user in the first subspace.

The second preset condition described herein may be set according to the requirement of the user. For example, the direction and angle of the body part of the user are selected as the second preset condition; whether an instrument is required and the size and weight of the instrument may be further selected as the second preset condition; similarity between the candidate actions and the standard action may be selected as the second preset condition. Various non-limiting examples of setting the second preset condition are listed here; in practical applications, the second preset condition may be set flexibly according to other requirement of the user, and the examples of this step should not be used to limit the scope of the disclosure. After selecting the target action in this step, the action that the user may complete in the first subspace is determined.

Step 304: Generate action prompt information according to the spatial position relationship between the related body parts of the user and the first subspace in the target action.

To better guide the user to complete the target action, this step generates action prompt information for the target action. As described above, the action prompt information includes description information about the user completing the next action (that is, the target action), such as description means of text or sound. Still taking the above example of steps 301 and 302 as an example, the spatial position relationship between the respective related body parts of the user and the first subspace may be a position relationship between the respective related body parts of the user and the space environment of the first subspace or maybe a position relationship between the respective related body parts of the user and an object in the first subspace. Assuming that the “hands” of the user being “on” the “floor” describes the position relationship between the related body parts of the user and the space environment of the first subspace, the action prompt information generated in this step may be “pressing hands on the floor”. For another example, “the hands of the user” being “on” the “tea table” describes the position relationship between the related body parts of the user and the object in the first subspace, and then the action prompt information generated in this step may be “pressing hands on the tea table”.

A method for generating action prompt information using the above steps 301 to 304 may have some differences according to different situations. The situations may include the following:

In response to the body part of the user needing the assistance of an object in the space environment:

The first subspace is the space environment where the first subspace is located and includes a space with an object providing the assistance. Step 301 may be as follows: determining a spatial position relationship between the respective related body parts of the user and an object providing the assistance in the first subspace in response to predicting that the user performs the standard action in the first subspace. Accordingly, step 304 may be as follows: generating the action prompt information according to the spatial position relationship between the respective related body parts of the user and the object in the first subspace in the target action.

(2) In response to the body part of the user needing to avoid an object in the space environment:

The first subspace is the space environment where the first subspace is located and does not include a space of the object to be avoided; Step 301 may be as follows: determining a spatial position of respective related body parts of the user in the first subspace in response to predicting that the user performs the standard action in the first subspace. Accordingly, step 304 may be as follows: generating the action prompt information according to the spatial position of the related body parts of the user in the first subspace in the target action.

The method according to various embodiments enables generating the action prompt information according to the user body information, the first subspace and the standard action information. The action prompt information describes how a user specifically completes a target action in a first subspace and also acts as key information for subsequently generation of a video corresponding to the target action.

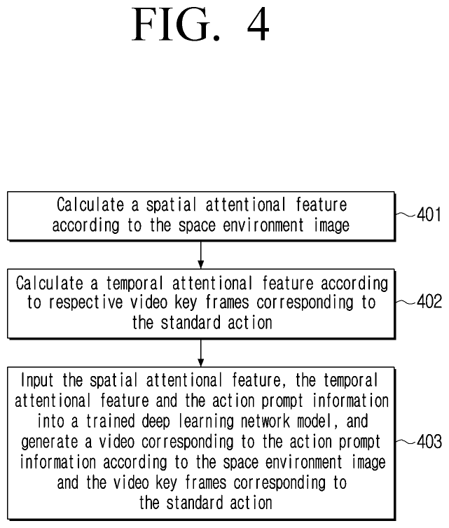

In various embodiments, step 104 may generate a video corresponding to the action prompt information according to the method illustrated in detail below with reference to FIG. 4.

FIG. 4 is a flowchart illustrating an example method for video generation corresponding to action prompt information according to various embodiments. As shown in FIG. 4, the method includes:

Step 401: Calculate a spatial attentional feature according to the space environment image.

In neural network learning, the more parameters of the model, the stronger the expression ability, but too much information may cause a problem of information overload. The attention mechanism may greatly reduce the amount of calculation by focusing on more critical information of the current task and reducing the attention to other information.

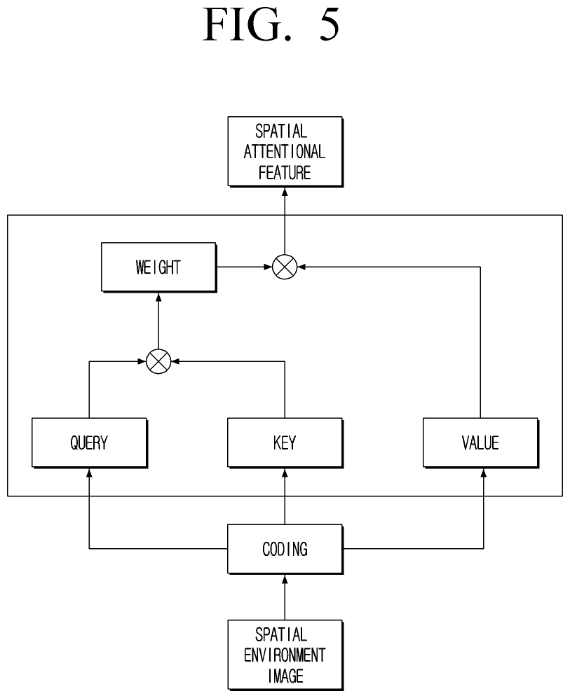

FIG. 5 is a diagram illustrating an example of computing a spatial attentional feature of a space environment image according to various embodiments. As shown in FIG. 5, when calculating a spatial attentional feature of a space environment image in an embodiment of the present application, the space environment image is first encoded to obtain a feature, followed by dividing the feature into three parts; a first part serves as a query (Qₑₙᵥ), a second part serves as a key (Kₑₙᵥ), and a third part is a corresponding value (Vₑₙᵥ). Calculation is performed based on the query (Qₑₙᵥ) and the key (Kₑₙᵥ) to obtain a similarity between the query (Qₑₙᵥ) and the key (Kₑₙᵥ), the similarity with the largest weight is determined, and a calculation is performed based on the query (Qₑₙᵥ) and the determined similarity to obtain the first spatial attentional feature. The first spatial attentional feature may serve as a spatial attentional feature of the space environment image described in step 401. The calculation is as follows:

$${Q}_{env} = {W}_{Q}^{env} {X}_{env} ,$$

$${K}_{env} = {W}_{K}^{env} {X}_{env} ,$$

$${V}_{env} = {W}_{v}^{env} {X}_{env} ,$$

$${H}_{env} = Attention ( {Q}_{env} , {K}_{env} , {V}_{env} ) ,$$

where Xₑₙᵥ represents an encoded space environment image; W_{Q}^{env} represents a weight for “query”; W_{K}^{env} represents a weight for “key”; Went represents a weight for “value”; Attention represents a self-attention calculation; and Hₑₙᵥ represents a calculated spatial attentional feature. In an embodiment, an area in the space environment image which contains an object will have a higher weight through the calculation of spatial attention.

Referring back to FIG. 4, in step 402: Calculate a temporal attentional feature according to respective video key frames corresponding to the standard action.

The standard action corresponds to a video, showing the process of completing the standard action, which contains several video key frames. This step first calculates the spatial attentional feature of the video key frame images, and then calculates the temporal attentional feature according to the spatial attentional feature of the video key frame images.

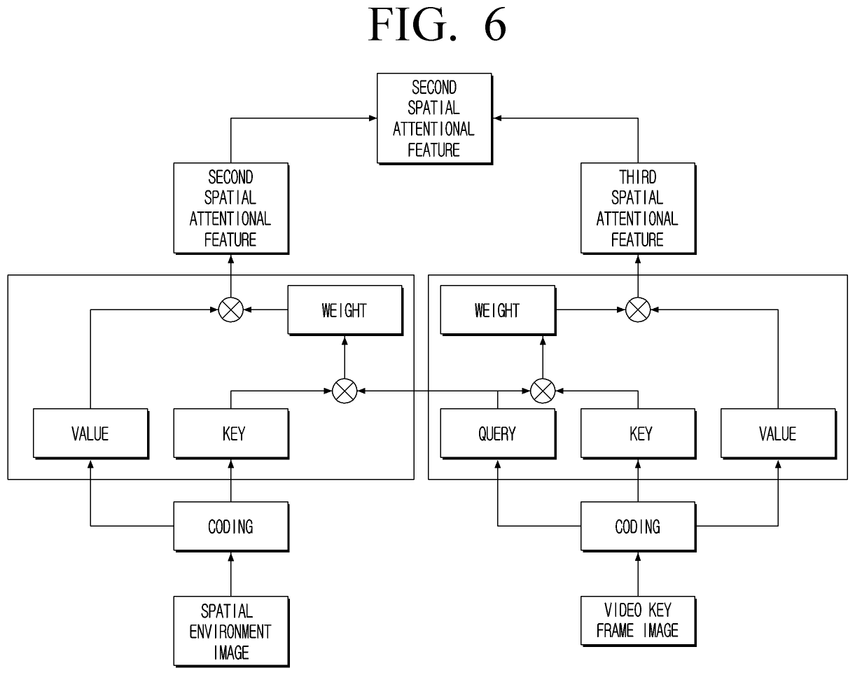

FIG. 6 is a diagram illustrating an example of computing spatial attentional feature of a video key frame image according to various embodiments. As shown in FIG. 6, when calculating the spatial attentional feature of the video frame image in an embodiment of the present disclosure, the space environment image and the video key frame images are encoded to obtain the features. The space environment image is divided into two parts after being encoded, the first part being a key (Kₑₙᵥ), and the second part being a corresponding value (Vₑₙᵥ). The video key frame image is divided into three parts after being encoded, the first part being a query (Q_{frame}), the second part being a key (K_{frame}), and the third part being a corresponding value (V_{frame}). On the one hand, for the space environment image, a calculation is performed based on the query (Q_{frame}) and the key (Kₑₙᵥ) corresponding to the video key frame image to obtain similarities between the query (Q_{frame}) and the key (Kₑₙᵥ) and a similarity with the largest weight is determined, and a calculation is performed based on the determined similarity and the key (Kₑₙᵥ) to obtain the spatial attentional feature of the space environment image. To distinguish from the above step 401, the calculated spatial attentional feature of the space environment image is referred to as a second spatial attentional feature herein. On the other hand, for the video key frame image, a calculation is performed based on the query (Q_{frame}) and key (K_{frame}) to obtain similarities between the query (Q_{frame}) and the key (K_{frame}), and a similarity with the largest weight is determined, and then a calculation is performed based on the determined similarity and the key (K_{frame}) to obtain the spatial attentional feature of the video key frame image. For purposes of distinguishing different spatial attentional features, the spatial attentional feature herein is referred to as a third spatial attentional feature. Finally, the second spatial attentional feature of the space environment image and the third spatial attentional feature of the video key frame images are combined to obtain a fourth spatial attentional feature. The calculation is as follows:

$${Q}_{frame} = {W}_{Q}^{frame} {X}_{frame} ,$$

$${K}_{frame} = {W}_{K}^{frame} {X}_{frame} ,$$

$${V}_{frame} = {W}_{v}^{frame} {X}_{frame} ,$$

$${K}_{env} = {W}_{K}^{env} {X}_{env} ,$$

$${V}_{env} = {W}_{v}^{env} {X}_{env} ,$$

$${H}_{frame} = Attention ( {Q}_{frame} , {K}_{frame} , {V}_{frame} ) + Attention ( {Q}_{frame} , {K}_{env} , {V}_{env} ) ,$$

where X_{frame} represents the encoded video key frame image;

$${W}_{Q}^{frame}$$

represents a weight for “query” of the video key frame image;

$${W}_{K}^{frame}$$

represents a weight for “key” of the video key frame image;

$${W}_{V}^{frame}$$

represents a weight for “value” of the video key frame image;

$${W}_{K}^{env}$$

represents a weigint “Key” of the space environment image;

$${W}_{V}^{env}$$

represents weight for “value” of the space environment image; Attention represents a self-attention calculation; and H_{frame} represents the calculated fourth spatial attentional feature.

The spatial attentional feature of each video key frame is calculated according to the above method, followed by arranging and coding according to the temporal order (such as a timestamp) to obtain the temporal attentional feature. In various embodiments, frames with significant action changes in the video key frames will have higher weight after the temporal attention calculations. It may be seen from the above description that the attentional feature of the space environment image is utilized in calculating the fourth spatial attentional feature of the video key frame image, therefore the calculation of the spatial attentional feature in step 401 and the calculation of the temporal attentional feature in step 402 are feature sharing.

Referring back to FIG. 4, in step 403: Input the spatial attentional feature, the temporal attentional feature, and the action prompt information into a trained deep learning network model, and generate a video corresponding to the action prompt information according to the space environment image and the video key frames corresponding to the standard action.

In practical applications, step 403 inputs the spatial attentional feature, the temporal attentional feature, and the action prompt information into a trained deep learning network model, and generates a video key frame corresponding to the action prompt information according to the space environment image and the video key frame corresponding to the standard action; then, the video key frame corresponding to the action prompt information is inserted into the video corresponding to the standard action information to generate the video corresponding to the action prompt information. Namely, the key frame of the video generated in step 403 is inserted into the original video to replace a relevant key frame in the original video, and integrated with the original video to generate a complete video for the user. The generated key frame may be one key frame or several key frames corresponding to an action; the involved insertion, replacement, integration, or covering may be implemented using relevant techniques of existing video processing, and will not be described in detail herein.

Since the spatial attentional feature and the temporal attentional feature have been calculated, and the action prompt information has been acquired before, the trained deep learning network model may get knowledge of an object needing attention in the space environment image, an action change needing attention in the standard action, and how the action is to be implemented according to the action prompt information, so as to generate a video corresponding to the action prompt information. For example, a certain standard action is an action of kicking the right leg directly in front, and it is known that there is an object (such as a chair) in front through the calculation of the spatial attentional feature; it is known at which time point there is an action change through the calculation of the temporal attentional feature; and it is known that kicking the right leg in the direction of 45 degrees to the right front through action prompt information; then, a key frame of kicking the right leg in the direction of 45 degrees to the right front may be inserted by deleting the key frame of the action of kicking the right leg directly in front, to generate a video corresponding to the prompt information. As to how to delete or insert a new key frame, and how to smooth the transition of the video after the insertion of the new key frame may be implemented according to the prior art, which will not be described in detail here. In practical applications, the action prompt information may also be edited to fulfill a requirement before being input into the deep learning network model. Generally, when generating the video corresponding to the action prompt information, the deep learning network model also needs the space environment image and the video key frame corresponding to the standard action, and therefore the space environment image and the video key frame corresponding to the standard action may also be input into the deep learning network model.

Further, in various embodiments, when the spatial attentional feature is calculated in step 401, the spatial attentional feature may be calculated using a first parameter feature (such as query (Qₑₙᵥ) and query (Qₑₙᵥ)), and when the temporal attentional feature is calculated in step 402, the temporal attentional feature may also be calculated using the first parameter feature (such as query (Qₑₙᵥ) and query (Qₑₙᵥ)), that is, the calculations of the spatial attentional feature and the temporal attentional feature are feature sharing. For example, when calculating the spatial attentional feature according to the space environment image, not only the area of the object in the space but also the area of the standard action is concerned. Likewise, when calculating the temporal attentional feature according to the video key frame corresponding to a standard action, not only the area of standard action but also the area of the object in the space is concerned. In a manner of parameter sharing according to an embodiment, the video corresponding to the generated action prompt information will better reflect the relationship between the space environment and the action, and the user experience is improved.

In various embodiments, a method may be applied to smart fitness exercise products. Existing smart fitness exercise products are generally divided into a front-end and a back end, where the user inputs personal fitness requirement and body conditions in the front-end, and the back-end analyzes and provides a personalized fitness solution. After the user selects the fitness solution, the front-end may play a fitness sports video to display specific actions, and guide the user to complete the action during exercise. The prior art generally does not focus on the space environment of the user, nor does it consider the relationship between the action and the space environment during exercise. If there are other objects in the space environment of the user, it is easy to have a collision with the objects when following the actions shown in the video, which will bring potential harm to the user and reduce the user experience.

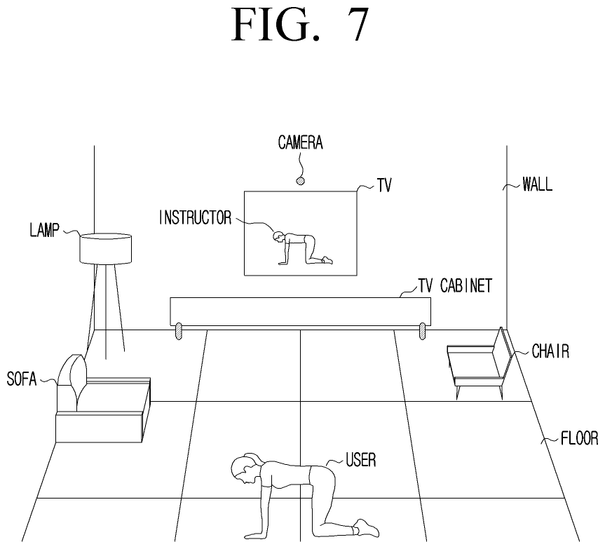

FIG. 7 is a diagram illustrating an example scenario according to various embodiments. As shown in FIG. 7, the scenario is an indoor living room, including a space environment where the living room is located and objects in the space environment, including at least a wall, a floor, a sofa, a chair, a television cabinet, a television set, and a lamp, and further including a camera for collection. The user is in the living room and can follow the actions displayed by the fitness instructor on the TV to exercise.

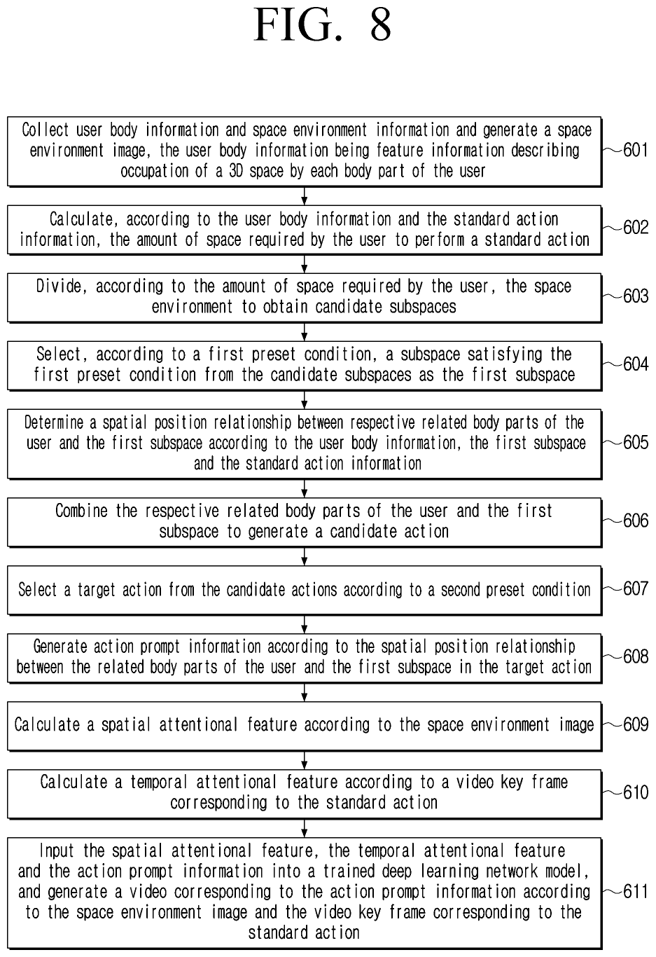

FIG. 8 is a flowchart illustrating an example method for video generation according to various embodiments. As shown in FIG. 8, the method includes:

Step 601: Collect user body information and space environment information and generate a space environment image, where the user body information is feature information describing occupation of a three-dimensional space by each body part of the user, wherein the space environment information is feature information describing space environment and occupation of the three-dimensional space by an object in the space environment.

This step is similar to step 101 of FIG. 1. The camera may collect the user body information and the space environment information, and the above information may be three-dimensional data or point cloud data. The user body information is feature information describing occupation of a three-dimensional space by each body part of the user, and may include but is not limited to a human body height and a human body proportion. A bone detection and bone point detection may be performed, and the bone length may be analyzed, to determine the size of each body part. The space environment information is feature information describing the space environment and occupation of a three-dimensional space by an object in the space environment and may include but is not limited to size, such as length, width and height, of the space environment, size, such as length, width and height, of the object, and attribute information such as the name of the object, the material of the object, and the softness and hardness of the object may be further detected and analyzed.

Step 602: Calculate, according to the user body information and the standard action information, the amount of space required by the user to perform a standard action.

This step is similar to step 201 of FIG. 2. The standard action information is feature information about the standard action which is not subject to the user body information and the space environment information. The standard action may be presented by a corresponding standard action video, and it may be a visually displayable animated action itself (such as an action performed by a real person or animated person), or an abstract action without a human-shaped video display (such as an action demonstrated by an arrow, symbol, text, sound, or part of the body). In an embodiment, the standard action video may be stored in the action database in advance and retrieved from the database according to a requirement of the user. For example, if the requirement of the user is to exercise a core muscle group, then a corresponding video, such as plank, may be selected from the action database. The standard action is demonstrated by an instructor in the video. The calculation of the amount of space required by the user may be implemented as follows: a) the video corresponding to the standard action is analyzed to obtain an action attribute of the standard action. The action attribute is feature information of the standard action, which may include a human body height and a human body proportion, and a bone detection and bone point detection may be performed and the bone length may be analyzed, to determine the size of each human body part in the action as well as a direction and an angle of each body part, and it is also possible to further analyze whether an instrument is required and the information such as the size, weight, and hardness of the instrument. b) The human body in the standard action video is replaced with the user, and then the amount of space required by the user is calculated according to the obtained user body information and the action attribute of the standard action. In practical applications, this step may be implemented using existing methods such as image segmentation and depth estimation, as will be appreciated by those skilled in the art.

Step 603: Divide, according to the amount of space required by the user, the space environment to obtain candidate subspaces.

This step is similar to step 202 in FIG. 2.

Step 604: Select, according to a first preset condition, a subspace satisfying the first preset condition from the candidate subspaces as the first subspace.

This step is similar to step 203 in FIG. 2, and the selecting condition may be set according to a practical situation. In practical applications, the subspaces screened out may be output as a list. It is assumed that an embodiment of the disclosure screens out the following three areas as the candidate subspace of the user for completing the plank: an area in the middle of the living room with 2 meters in length and 1 meter in width; an area utilizing a sofa covering the sofa and an area on the right side of the sofa with 1.5 meters in length and 1 meter in width; and an area utilizing a chair covering the chair and an area on the left side of the chair with 1 meter in length and 1 meter in width. The list of the candidate subspaces is as follows:

TABLE 1

| Index | Subspace |
|---|---|
| 1 | Middle area, 2 meters in length and 1 meter in |
| | width |
| 2 | Sofa and an area on the right side of the sofa with |
| | 1.5 meters in length and 1 meter in width |
| 3 | Chair and an area on the left side of the chair |
| | with 1 meter in length and 1 meter in width |
| . . . | . . . |

If the user wishes to have the assistance of an object in the space environment, item 2 and/or item 3 may be selected as the first subspace. If the user wishes to avoid an object in the space environment, item 1 may be selected as the first subspace. The above steps 602 to 604 achieve the purpose of determining the first subspace required for the next action of the user according to the user body information, the space environment information and standard action information.

Step 605: Determine a spatial position relationship between respective related body parts of the user and the first subspace according to the user body information, the first subspace and the standard action information.

This step is similar to step 301 in FIG. 3. The related body part of the user refers to a body part related to a standard action. The spatial position relationship refers to a specific position of the related body parts of the user in the first subspace. The spatial position relationship between the respective related body parts of the user and the first subspace may describe a position relationship between the respective related body parts of the user and space environment of the first subspace or may describe a position relationship between the respective related body parts of the user and the object in the first subspace. It is assumed that the user wishes to complete the plank with the assistance of an object in the space environment, the position relationship between the hands of the user and the sofa or chair needs to be determined. It is assumed that the user wishes to avoid an object in the space environment, and the position relationship between the hands of the user and the floor is determined. Herein “hands” are taken as an example body part. In practical applications, it may be necessary to determine the spatial position relationship between other body parts and the first subspace.

Step 606: Combine the respective related body parts of the user and the first subspace to generate candidate actions.

This step is similar to step 302 in FIG. 3. The combination of the respective related body parts of the user and the first subspace may be described as a combination of the respective related body parts of the user and the space environment of the first subspace, or as a combination of the respective related body parts of the user and the object in the first subspace. Taking the above-plank as an example, assuming that the first subspace selected is the middle area corresponding to item 1 in Table 1, the combination of the hands of the user and the floor and the combination of the feet of the user and the floor may be described, and the combination with the instrument may be further described. The combination of the respective related body parts of the user and the first subspace may be represented by “+”, and the generated candidate actions are shown in Table 2 below:

TABLE 2

| Index | Action list |
|---|---|
| 1 | Hands + floor, feet + floor |
| 2 | Right hand + floor, left arm front raise, left hand + 1 kg dumbbell, |
| | feet + floor |
| 3 | Hands + floor, knees + floor |
| . . . | |

For example, this step combines the respective related body parts of the user and the first subspace to generate a plurality of candidate actions, all of which belong to the plank action required by the user.

Step 607: Select a target action from the candidate actions according to a second preset condition, where the target action is a next action to be completed by the user in the first subspace.

This step is similar to step 303 in FIG. 3. The second preset condition may be set according to a requirement of the user, and a plurality of different conditions may be set to implement a selection one by one, and a combination of the plurality of different conditions are referred to as the second preset condition. For example, the first selection may be performed according to the size of each body part, the direction and angle of each body part, whether an instrument is required and conditions such as size, weight, and hardness of the instrument. For another example, a second selection may be performed according to a similarity between respective candidate actions and the standard action, so as to determine a final target action. In an embodiment, it is assumed that the first condition is that no instrument is required, thus item 2 in Table 2 is excluded. Assuming that the second condition is a low similarity with the standard action, then item 1 in Table 2 is selected out. The second preset condition in this step is a combination of the first condition (no instrument required) and the second condition (low similarity), thus item 3 in Table 2 is used as the final target action. This is merely a simple example, and conditions may be set according to circumstances in practical applications, and this is not intended to limit the scope of protection of the present application.

Step 608: Generate action prompt information according to the spatial position relationship between the respective related body parts of the user and the first subspace in the target action.

This step is similar to step 304 of FIG. 3. Action prompt information is description information for the user to implement a next action (namely, the target action) to facilitate subsequent generation of a video. After selecting the target action, the spatial position relationship between the respective related body parts of the user and the first subspace may be accurately determined. Taking Table 2 as an example, assuming that the selected target action is item 3 in Table 2 (hands+floor, knees+floor), then the generated action prompt information may be expressed as “plank, pressing hands on the floor with knees landing”. This is merely a simple example, and there may be detailed and accurate descriptions in practical applications.

The above steps 605 to 608 may generate the action prompt information according to the user body information, the first subspace and the standard action information.

Step 609: Calculate a spatial attentional feature according to the space environment image.

This step is similar to step 401 in FIG. 4.

Step 610: Calculate a temporal attentional feature according to a video key frame corresponding to the standard action.

This step is similar to step 402 in FIG. 4.

Step 611: Input the spatial attentional feature, the temporal attentional feature, and the action prompt information into a trained deep learning network model, and generate a video corresponding to the action prompt information according to the space environment image and the video key frame corresponding to the standard action.

This step is similar to step 403 in FIG. 4. The deep learning network model may use U-Net, and other models may be used in practical applications, which is not limited herein. In practical applications, the action prompt information may be edited into a required form by the text editor before being input into the deep learning network model. In addition, if U-Net is used, the output thereof is usually feature information, which may be understood as low-resolution video, needs to be input into an automatic codec to regenerate the video corresponding to the action prompt information.

In an embodiment, a camera collects the user body information and the space environment information and generates a space environment image; a first subspace required by a user for the next action is determined as a middle area; the target action to be completed is determined as “hands+floor, knees+floor”, and the action prompt information “plank, pressing hands on the floor with knees landing” is generated; then, the spatial attentional feature is calculated according to the space environment image, the temporal attentional feature is calculated according to the video key frame corresponding to the standard action, and the spatial attentional feature, the temporal attentional feature, and the action prompt information are input into the U-Net, and then the video corresponding to the action prompt information is generated via the automatic codec. That is, the standard action of “pressing hands on the floor with feet pedaling the floor” is adjusted to the target action of “pressing hands on the floor with knees landing”, and the action is demonstrated by an instructor in the video. So far, the user may follow the demonstration of the instructor in the video to complete the action, and this process is completely adjusted automatically according to the requirement of the user, which improves the user experience.

In various embodiments, the application scenario is similar to FIG. 7, actions of different difficulty degrees may also be generated for user's selection. Based on the above, steps 601 to 603 of FIG. 8 are similar to those of FIG. 4, and the description thereof may not be repeated here. The differences are as follows:

In step 604, a plurality of subspaces is selected according to the first preset condition from candidate subspaces, namely, the number of the determined first subspaces is N, and N is a natural number greater than one. It is assumed that the list of candidate subspaces obtained in step 603 is as follows:

TABLE 3

| Serial | |
|---|---|
| number | Subspace |
| 1 | Middle area, 2 meters in length and 1 meter in |
| | width |
| 2 | Sofa and an area on the right side of the sofa with |
| | 1.5 meters in length and 1 meter in width |
| 3 | Chair and an area on the left side of the chair |
| | with 1 meter in length and 1 meter in width |
| 4 | Wall on right side, with 0.5 meter in length and |
| | 0.5 meter in width |
| . . . | |

It is assumed that item 1, item 2, and item 4 are selected as the first subspaces, namely, all three areas may be used to complete the plank action, but the difficulty of the plank action completed in the three areas is different.

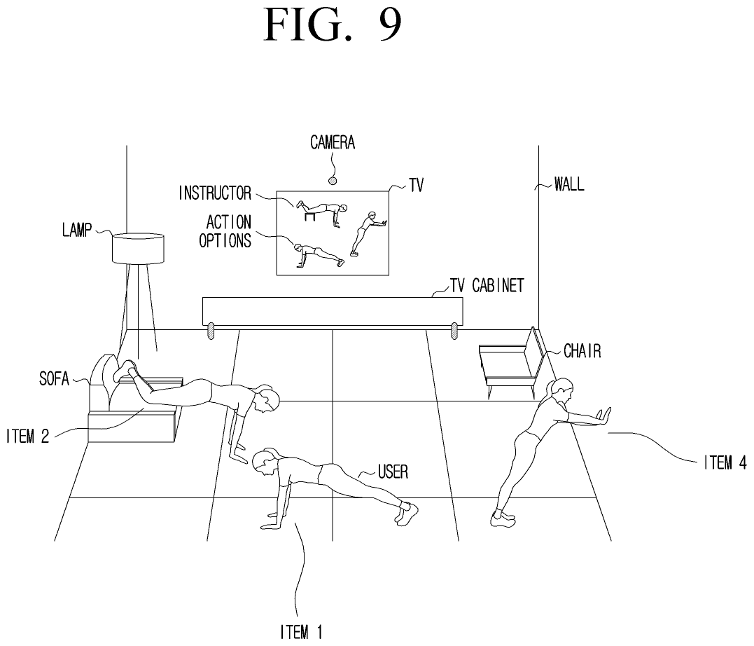

FIG. 9 is a diagram illustrating example actions of different difficulty degrees according to various embodiments. As shown in FIG. 9, the area of item 4 is close to the wall and is a narrow area, and the plank may be completed in a manner of pressing hands against the wall and stepping on the floor with both feet, which has the lowest difficulty degree. The area of item 1 is in the indoor middle area, and the plank may be completed in a manner of pressing hands against the floor with feet pedaling the floor, which has a moderate difficulty degree. The area of item 2 contains the sofa and the area on the right side of the sofa, and the plank may be completed in a manner of pressing hands against the floor with knees landing on the floor, which has the highest difficulty degree.

Steps 605 to 611 are similar to the method of FIG. 8, and videos with different difficulty degrees are generated according to the above plurality of first subspaces for selection of the user.

For example, in step 605, the spatial position relationship between the respective related body parts of the user and the first subspace is respectively determined for N different first subspaces.

In step 606, the respective related body parts of the user and the first subspace are combined to generate candidate actions for N different first subspaces, respectively. In an embodiment, it is assumed that the generated candidate actions are as shown in Table 4:

TABLE 4

| Index | Action list |
|---|---|
| 1 | Hands + walls, feet + floor |
| 2 | Hands + floor, soles of feet + floor |
| 3 | Hands + floor, knees + sofa |
| . . . | . . . |

In step 607, all the N actions with different difficulty degrees are selected as the target actions.

In step 608, for the above N target actions with different difficulty degrees, N pieces of action prompt information with different difficulty degrees are generated according to the spatial position relationship between the respective related body parts of the user in each target action and the corresponding first subspace. For example, in this step, in the N first subspaces, N pieces of action prompt information with different difficulty degrees are generated according to the user body information, the first subspace and the standard action information. For example, “plank, pressing hands against the wall, with feet stepping on the floor”, “plank, pressing hands against the floor, with soles of feet pedaling the floor”, and “plank, pressing hands against the floor with knees landing on the floor” will be generated.

Similarly, for the above N target actions with different difficulty degrees, videos respectively corresponding to the N pieces of action prompt information with different difficulty degrees will be generated according to steps 609 to 611.

Accordingly, after the videos respectively corresponding to the N pieces of action prompt information with different difficulty degrees are generated, it is also possible to further recommend one of the videos corresponding to the N first subspaces to the user according to the acquired user body condition, and the user body condition is determined by the user body information and the previously acquired historical user operation information. In practical applications, it is also possible to input in advance whether the user is physically ill and exercise capability parameters, or to save historical user operation information, such as the difficulty degree the user has historically selected, and the user body condition may be determined (for example, weak, general, or strong) based on these pieces of user body information and historical user operation information. In the illustration of actions with different difficulty degrees shown in FIG. 9, if the user body condition is weak, the user may be recommended or select the action with the lowest difficulty degree, to complete the plank in a manner of pressing hands against the wall with two feet stepping on the floor. If the user body condition is general, the user may be recommended or select the action with a moderate difficulty degree, to complete the plank in a manner of pressing hands against the floor with soles of feet pedaling the floor. If the user body condition is strong, the user may be recommended or select the action with the highest difficulty degree, to complete the plank in a manner of pressing hands against the floor with knees landing on the floor.

Demonstration videos with different difficulty degrees may be generated using various embodiments, and the users may flexibly select an appropriate difficulty degree according to their own requirement, and follow the demonstration of an instructor in the corresponding video to complete the action, which further improves the user experience.

The various embodiments described above may generate the video either before user's exercise or in real-time during the exercise of the user. In various embodiments, new action videos can also be generated in real time based on temporary occurrences.

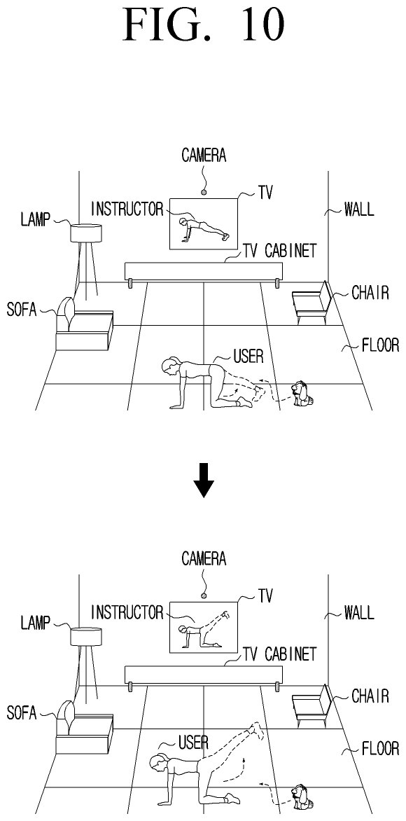

FIG. 10 is a diagram illustrating an example scenario according to various embodiments. As shown, a movable object such as a puppy suddenly rushes in during user's exercise. If performing following existing actions, there may be a collision with the puppy which may lead to potential harm.

Step 601 may further include collecting movable object information, where the movable object information is feature information describing occupation of the three-dimensional space by the movable object. For example, when the user body information and the space environment information are collected and the space environment image is generated, the movable object information may also be collected if the movable object enters the space environment of the user.

In steps 602 to 604 the first subspace required for the next action of the user is determined based on the user body information, space environment information and standard action information. The difference is that in determining the first subspace, it may further include: calculating, in response to the movable object information in the space environment being collected, a movement trajectory of the user performing the standard action, and calculating a movement trajectory of the movable object; determining whether the movement trajectory of the user performing the standard action overlaps with the movement trajectory of the movable object, and deleting, in response to there is the overlap, a candidate subspace corresponding to the overlap when selecting a subspace satisfying the first preset condition.

For example, when a movable object enters the space environment of the user, it is possible to predict whether its movement trajectory has collision with the movement trajectory of the user, and select out the candidate subspace where the collision may occur.

In steps 605 to 611, since the candidate subspace where the collision may occur is selected out, the target action determined in the subsequent step 607 will not fall in the subspace where the collision may occur, for example, the actions generated in steps 609 to 611 will not fall in the subspace where the collision may occur. Similarly, the user follows the demonstration of an instructor in the corresponding video to complete the action, avoiding the next action of the user being involved in a collision with the movable object. Method embodiment seven of the present application may collect a movable object temporarily entering the space in real-time, and automatically generate an action to avoid collision with the movement trajectory of the movable object, without the need of the user's attention on the movable object, which improves the user experience.

In addition, if the original video conforming to the space environment has been generated in advance, a new generated as a result of temporarily collecting the movable object may be inserted into the original video. For example, as illustrated in FIG. 10, when the user completes the plank action, the right leg should be lifted to push out right behind, but since the puppy's entrance is temporarily collected, it is predicted that the movement trajectory of the puppy will have a collision right behind the user, and then the newly inserted video may adjust the action to lift the right leg upwards, thereby avoiding the puppy. The entire process is automatically provided by the smart fitness exercise product in an embodiment, without the need of the user's attention on the puppy, which improves the user's experience.

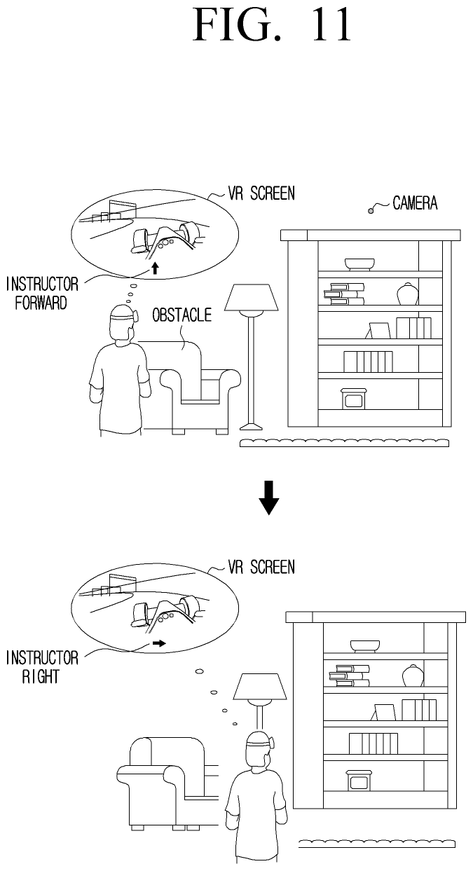

In various embodiments, the method may also be applied to a VR game, the application scenario of which is shown in FIG. 11. As shown in FIG. 11, the user confirms through the VR glasses that the game task should be step forward following the direction of the arrow. In the prior art of VR games, since the user wears VR glasses and cannot pay attention to the real space environment of the user, the VR games usually detect whether the user has an obstacle in the real space environment, and if so, an alarm is sent to the user to avoid the obstacle, or a corresponding obstacle is generated in the virtual space environment to prompt the user. These obstacle avoidance methods of the prior art force the user to pay attention to the surrounding obstacles to be avoided, inevitably increasing the abruptness sense, and reducing the user's experience in the process of playing VR games.

With respect to the deficiencies of the prior art, the disclosure further provides a method to address the problem of obstacle avoidance in VR games.

Step 601 is the same as that of FIG. 8, in which user body information and space environment information are collected and a space environment image is generated.

Steps 602 to 604 are substantially the same as those of FIG. 8, in which the first subspace required for the next action of the user is determined according to the user body information, space environment information and standard action information. The difference is that the determination of the first subspace may further include: calculating a movement trajectory of the user performing the standard action, determining whether the movement trajectory of the user performing the standard action has a collision with the space environment and an object in the space environment, and if there is a collision, deleting a candidate subspace corresponding to the collision during the process of selecting a subspace satisfying the first preset condition.

For example, when the user wears VR glasses to perform an in-game task, their body actions may have a collision with the real space environment. For example, the user requires to take a step forward in the task, but there is a sofa in front of the user in the real space environment, and there is a collision. In this case, however, when it is determined that the movement trajectory of the user performing the standard action has a collision with the space environment and the object in the space environment, the candidate subspace where the collision may occur is selected out. The standard action described herein is an abstract illustration without a human-shaped video display (such as an action guided by an arrow, symbol, text, sound, or part of the body). In an embodiment of the present application, it is assumed that the indication provided by the VR game to the user through the arrow, indicating the task to be executed by the user, is that the user needs to step forward following the direction of the arrow. Then the arrow here is the standard action.

The steps 605 to 611 are the same as those in FIG. 8. Since the candidate subspace where the collision may occur is selected out, the target action determined in the subsequent step 607 will not fall in the subspace where the collision may occur, that is, the action in the video generated in steps 609 to 611 will not fall in the subspace where the collision may occur. Similarly, the user completing the action as directed by the game may avoid a collision between the next action of the user and the space environment and an object in the space environment. Assuming that the user may have a collision with the sofa if directly step forward following the forward arrow as shown in FIG. 11, the action in the video generated in steps 609 to 611 may be a rightward arrow, prompting the user to step leftward, to avoid the collision with the sofa directly in front. Various embodiments may predict an obstacle existing in a real space environment of a user in a VR game, and automatically generate an action for avoiding the obstacle, without the need of the user's attention, which improves the user's experience.

In addition, if the original video (that is, the video of the VR game itself) has been generated in advance, a new video generated as a result of temporarily collecting the obstacle may be inserted into the original video. For example, the original video of the game prompts the user to step forward according to the forward arrow. Since a situation that an obstacle sofa exists in the front is collected, and the movement trajectory of the user is predicted to have a collision with the sofa, the inserted new video adjusts the arrow to the rightward, thus the user will step to the right following the arrow, thereby avoiding the obstacle sofa. The entire process is automatically implemented by the VR game product, without requiring the user to pay attention to obstacle, which improves the user's experience.

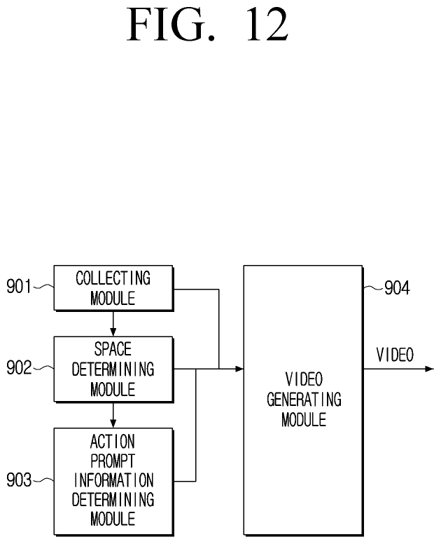

FIG. 12 is a block diagram illustrating an example configuration of apparatus according to various embodiments. As shown in FIG. 12, the apparatus includes a collecting module 901, a space determining module 902, an action prompt information determining module 903, and a video generating module 904. Each of these modules may include various circuitry (e.g., processing circuitry) and/or executable program instructions.

The collecting module 901 may include various circuitry (e.g., a camera) and/or executable program instructions and is configured to collect user body information and space environment information and generate a space environment image, where the user body information is feature information describing occupation of a three-dimensional space by each body part of the user, and the space environment information is feature information describing space environment and occupation of the three-dimensional space by an object in the space environment. The collecting module 901, such as a three-dimensional camera, is configured to collect user body information and space environment information, and the collected data may be three-dimensional data or point cloud data. The user body information is feature information describing occupation of a three-dimensional space by each body part of the user, and may include but is not limited to a human body height and a human body proportion. Bone detection and bone point detection may be performed, and the bone length may be analyzed, to determine the size of each body part. The space environment information is feature information describing the space environment and occupation of the three-dimensional space by an object in the space environment and may include but is not limited to length, width, and height describing the space environment, length, width, and height describing the object. It is also possible to further detect and analyze attribute information such as the name of the object, the material of the object, and the softness and hardness of the object.

The space determining module 902 may include various circuitry and/or executable program instructions and is configured to determine a first subspace required for the next action of the user according to the user body information, the space environment information and the standard action information, the standard action information being feature information about a standard action which is not subject to the user body information and the space environment information. The standard action information refers to the feature information about a standard action which is not subject to the user body information and the space environment information, but may correspond to a visually displayable animated action itself (such as an action performed by a real person or an animated person), or may also correspond to an abstract action without a human-shaped video display (such as an action guided with the assistance of arrow, symbol, text, sound, or a certain part of the body). Regardless of the form of the standard action, the actual space environment required for the user to perform the standard action is the first subspace described herein. In practical applications, the space determining module 902 may also be omitted if the first subspace is fixed.

The action prompt information determining module 903 may include various circuitry and/or executable program instructions and is configured to generate action prompt information according to the user body information, the first subspace, and the standard action information, where the action prompt information is description information about a next action of the user. Once the first subspace is determined, the user may perform the next action in the first subspace. Since the standard action is an action that is not subject to the user body information and the space environment information, the next action performed by the user may be different from the standard action after considering the actual user body information and the space environment information. Depending on the requirement of the user, the next action may be completed with the assistance of the object in the space environment or by avoiding the object in the space environment. To meet the requirement of the user, this step generates action prompt information, and the next action may be completed with the assistance of the object in the space environment or by avoiding the object in the space environment. In practical applications, if the above space determining module 902 is omitted, the process of generating the action prompt information according to the user body information, the space environment information and standard action information by the action prompt information determining module 903 is changed as: generating the action prompt information according to the user body information, the first subspace, and the standard action information.

The video generating module 904 may include various circuitry and/or executable program instructions and is configured to generate a video corresponding to the action prompt information according to the space environment image, a video key frame corresponding to the standard action information and the action prompt information. The video corresponding to the action prompt information described herein may be a visually displayable animated action itself (such as an action performed by a real person or animated person), or an abstract action without a human-shaped video display (such as an action guided by an arrow, symbol, text, sound, or part of the body).

For example, the collecting module 901 collects the user body information and the space environment information and generates a space environment image; the space determining module 902 determines the first subspace required for the next action of the user; the action prompt information determining module 903 generates action prompt information; the video generating module 904 generates a video corresponding to the action prompt information. If the user performs the next action according to the video in this step, the action may be more compatible with the user body conditions and actual space environment. Various embodiments may acquire user body information and space environment information and analyzes the standard action information, determines the next action of the user under the consideration of the factors of the user own body condition and actual space environment, and generates a new video which is more compatible with the user body condition and space environment. The generated new video can avoid the collision between the user and the space, and does not just provide simple reminders, which will not introduce an abruptness sense, thus the user experience when following the video content is improved.

The internal structure of the space determining module 902 is further provided in various embodiments.

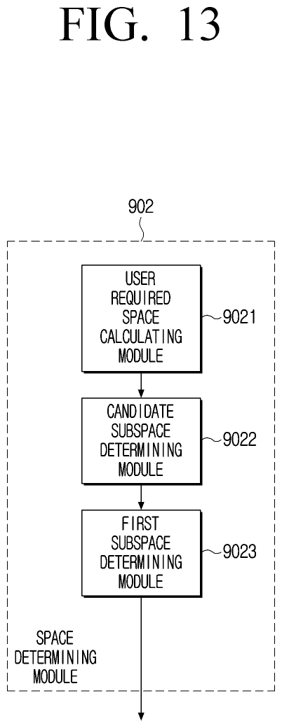

FIG. 13 is a block diagram illustrating an example configuration of an internal structure of a space determining module 902 according to various embodiments. As shown in FIG. 13, the space determining module 902 includes the user required space calculating module 9021, the candidate subspace determining module 9022, and the first subspace determining module 9023. Each of these modules may include various circuitry (e.g., processing circuitry) and/or executable program instructions.

The user required space calculating module 9021 may include various circuitry and/or executable program instructions and is configured to calculate, according to the user body information and the standard action information, the amount of space required by the user to perform the standard action. Due to the different body conditions of different users, some users are strong and need more space to complete the standard action, while some users are thin and need less space to complete the standard action. To select a suitable space, this step needs first to calculate the amount of space required by the user.

The candidate subspace determining module 9022 may include various circuitry and/or executable program instructions and is configured to divide, according to the amount of space required by the user, the space environment to obtain candidate subspaces. Generally, the space environment will be larger than the amount of space required by the user to complete a certain action, and the whole space environment may be divided into several small spaces in advance, namely, the candidate subspace in this step.

The first subspace determining module 9023 may include various circuitry and/or executable program instructions and is configured to select, according to a first preset condition, a subspace satisfying the first preset condition from the candidate subspaces as the first subspace. After the whole space environment is divided into several small candidate subspaces, it is necessary to select a suitable subspace from the several candidate subspaces as the first subspace. The selecting conditions may be set according to a practical situation. For example, a user may wish for the assistance of the object in the space environment, and whether an object is contained may be taken as a selecting condition, to reserve a candidate subspace containing the object providing the assistance while remove other candidate subspaces; alternatively, the user may wish to avoid the object in the space environment, and whether an object is contained may be taken as a selecting condition to remove the space containing the object to be avoided while retaining other candidate subspaces.

For example, in the space determining module 902, the user required space calculating module 9021 firstly calculates the amount of space required by the user when performing the standard action; the candidate subspace determining module 9022 divides the space environment to obtain the candidate subspaces; the first subspace determining module 9023 selects a subspace satisfying first preset the condition from the candidate subspaces as the first subspace. A first subspace satisfying the first preset condition may be selected from the space environment, whereby the space environment may be used more flexibly.

The internal structure of the action prompt information determining module 903 is further provided in various embodiments.

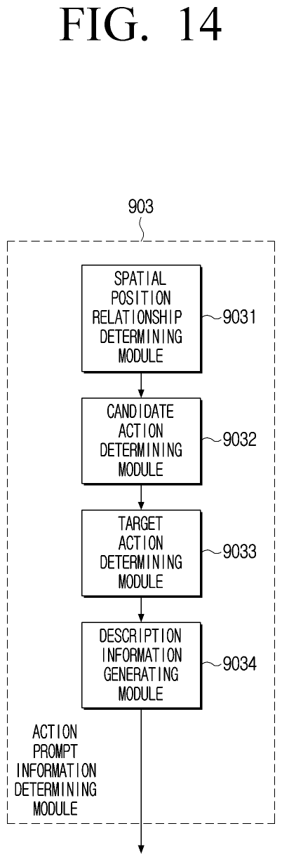

FIG. 14 is a block diagram illustrating an example configuration of an action prompt information determining module 903 according to various embodiments. As shown in FIG. 14, the action prompt information determining module 903 includes spatial position relationship determining module 9031, candidate action determining module 9032, target action determining module 9033, and description information generating module 9034. Each of which include various circuitry (e.g., processing circuitry) and/or executable program instructions.

The spatial position relationship determining module 9031 may include various circuitry and/or executable program instructions and is configured to determine a spatial position relationship between respective related body parts of the user and the first subspace according to the user body information, the first subspace, and the standard action information. The spatial position relationship refers to a specific position of the respective related body parts of the user in the first subspace. The first subspace may be understood as a subset of the space environment and is feature information describing a part of the space environment and occupation of the three-dimensional space by an object in the part of the space environment. The spatial position relationship between the respective related body parts of the user and the first subspace may describe a position relationship between the respective related body parts of the user and the space environment of the first subspace or may describe a position relationship between the respective related body parts of the user and the object in the first subspace.

The candidate action determining module 9032 may include various circuitry and/or executable program instructions and is configured to combine the respective related body parts of the user and the first subspace to generate a candidate action. There may be a plurality of first subspaces divided, for example, the user may perform a standard action in a plurality of different first subspaces. Further, to accurately describe the action, this step also needs to consider how the respective related body parts of the user and the first subspace are combined. “Combine” as described herein may be refer, for example, to how the respective related body parts of the user is “in contact” with the first subspace. It is also possible to adjust the standard actions when combining the respective related body parts of the user with the first subspace. Regardless of whether the action performed in the first subspace differs from the standard action, it is a candidate action generated by combining the respective related body parts of the user and the first subspace in an embodiment.

The target action determining module 9033 may include various circuitry and/or executable program instructions and is configured to select a target action from the candidate actions according to a second preset condition, where the target action is the next action to be completed by the user in the first subspace. The second preset condition described herein may be set according to the requirement of the user.

The description information generating module 9034 may include various circuitry and/or executable program instructions and is configured to generate the action prompt information according to the spatial position relationship between the respective related body parts of the user and the first subspace in the target action. The action prompt information is description information about the user completing the next action (that is, the target action), such as description means of text or sound. The spatial position relationship between the respective related body parts of the user and the first subspace may describe a position relationship between the respective related body parts of the user and the space environment of the first subspace or may describe a position relationship between the respective related body parts of the user and the object in the first subspace.

A method for generating action prompt information using the above apparatus may have some differences according to different situations. The situations may be as follows:

In response to the body part of the user with the assistance of an object in the space environment:

The first subspace is the space environment where the first subspace is located and includes a space of the object providing the assistance. The spatial position relationship determining module 9031 is configured to determine a spatial position relationship between the respective related body parts of the user and an object providing the assistance in the first subspace in response to predicting that the user performs the standard action in the first subspace. Accordingly, the description information generating module 9034 is configured to generate the action prompt information according to the spatial position relationship between the respective related body parts of the user and the object in the first subspace in the target action.

(2) In response to the body part of the user needing to avoid an object in the space environment:

The first subspace is the space environment where the first subspace is located and does not include a space of the object to be avoided; The spatial position relationship determining module 9031 is configured to determine a spatial position of respective related body parts of the user in the first subspace in response to predicting that the user performs the standard action in the first subspace. Accordingly, the description information generating module 9034 is configured to generate the action prompt information according to the spatial position of the respective related body parts of the user in the first subspace in the target action.

Various embodiments enable generating the action prompt information according to the user body information, the first subspace, and the standard action information. The action prompt information describes how a user completes a target action in a first subspace and also acts as key information for subsequent generation of a video corresponding to the target action.

The internal structure of the video generating module 904 is further provided in various embodiments.

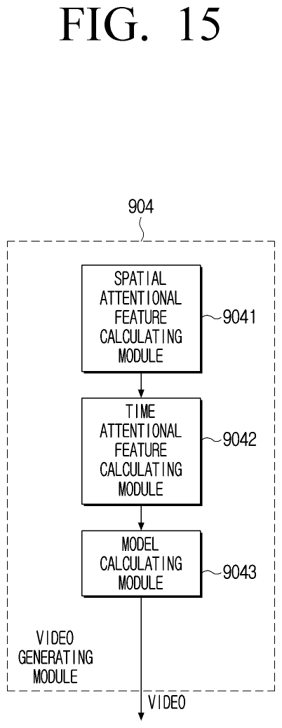

FIG. 15 is a block diagram illustrating an example configuration of a video generating module 904 as according to various embodiments. As shown in FIG. 15, the apparatus includes spatial attentional feature calculation module 9041, temporal attentional feature calculation module 9042, and model calculation module 9043. Each of which may include various circuitry (e.g., processing circuitry) and/or executable program instructions.

The spatial attentional feature calculation module 9041 may include various circuitry and/or executable program instructions and is configured to calculate a spatial attentional feature according to the space environment image. When calculating a spatial attentional feature of a space environment image, the space environment image is first encoded to obtain a feature, followed by dividing the feature into three parts; a first part serves as a query (Qₑₙᵥ), a second part serves as a key (Kₑₙᵥ), and a third part is a corresponding value (Vₑₙᵥ). Calculation is performed based on the query (Qₑₙᵥ) and the key (Kₑₙᵥ) to obtain a similarity between the query (Qₑₙᵥ) and the key (Kₑₙᵥ), and the similarity with the largest weight is determined, and a calculation is performed based on the query (Qₑₙᵥ) and the determined similarity to obtain the first spatial attentional feature. In an embodiment, an area in the space environment image which contains an object will have a higher weight through the calculation of spatial attention.

The temporal attentional feature calculation module 9042 may include various circuitry and/or executable program instructions and is configured to calculate a temporal attentional feature according to a video key frame corresponding to the standard action. This step first calculates the spatial attentional feature of the video key frame image, and then calculates the temporal attentional feature according to the spatial attentional feature of the video key frame images. When calculating the spatial attentional feature of the video frame image, the space environment image and the video key frame image are encoded to obtain the features. The space environment image is divided into two parts after being encoded, the first part being a query (Qₑₙᵥ), and the second part being ( ) The video key frame image is divided into three parts after being encoded, the first part being a query (Q_{frame}), the second part being a key (K_{frame}), and the third part being a corresponding value (V_{frame}). On the one hand, for the space environment image, a calculation is performed on the query (Q_{frame}) and the key (Kₑₙᵥ) corresponding to the video key frame image to obtain similarities between the query (Q_{frame}) and the key (Kₑₙᵥ) and a similarity with the largest weight is determined, and a calculation is performed based on the determined similarity and the key (Kₑₙᵥ) to obtain the spatial attentional feature of the space environment image. The spatial attentional feature of each video key frame is calculated according to the above method, followed by arranging and coding according to the temporal order (such as a timestamp) to obtain the temporal attentional feature. In an embodiment, frames with significant action changes in the video key frames will have higher weight over temporal attention calculations. It may be seen from the above description that the attentional feature in the space environment image is utilized in calculating the fourth spatial attentional feature of the video key frame image, therefore the calculation of the spatial attentional feature in step 401 and the calculation of the temporal attentional feature in step 402 are feature sharing.

The model calculation module 9043 may include various circuitry and/or executable program instructions and is configured to input the spatial attentional feature, the temporal attentional feature, and the action prompt information into a trained deep learning network model, and generate a video corresponding to the action prompt information according to the space environment image and the video key frames corresponding to the standard action. Since the spatial attentional feature and the temporal attentional feature have been calculated, and the action prompt information has been acquired before, the trained deep learning network model may learn the objects needing attention in the space environment image, may get knowledge of the action change needing attention in the standard action, and the action is to be implemented according to the action prompt information, so as to generate a video corresponding to the action prompt information. In practical applications, the action prompt information may also be edited to fulfill a requirement before being input into the deep learning network model. Generally, when generating the video corresponding to the action prompt information, the deep learning network model also needs the space environment image and the video key frame corresponding to the standard action, and therefore the space environment image and the video key frame corresponding to the standard action also needs to be input into the deep learning network model.

Further, in various embodiments, the spatial attentional feature calculation module 9041 calculates the spatial attentional feature using the first parameter feature; the temporal attentional feature calculation module 9042 calculates the temporal attentional feature using the first parameter feature, that is, the calculations of the spatial attentional feature and temporal attentional feature are feature sharing. For example, when calculating the spatial attentional feature according to the space environment image, not only the area of the object in the space but also the area of the standard action is concerned. Likewise, when calculating the temporal attentional feature according to the video key frame corresponding to a standard action, not only the area of the standard action but also the area of the object in the space is concerned. In a manner of parameter sharing, the video corresponding to the generated action prompt information will better reflect the relationship between the space environment and the action, and the user experience is improved.

In various embodiments, e.g., FIGS. 12, 13, 14 and 15 described above may be combined in whole or in part for video generation.

In various embodiments, actions of different difficulty degrees may also be generated for user selection. Based on the above, the first subspace determining module 9023 selects a subspace satisfying the first preset condition from the candidate subspace as a plurality of subspace according to the first preset condition, namely, the number of the determined first subspaces is N. Accordingly, the spatial position relationship determining module 9031 may determine the spatial position relationship between the respective related body parts of the user and the first subspace for different first subspaces. The candidate action determining module 9032 combines the respective related body parts of the user and the first subspace for different first subspaces to generate candidate actions. The target action determining module 9033 selects actions with different difficulty degrees as target actions. The description information generating module 9034 generates action prompt information according to the spatial position relationship between the respective related body parts of the user in each target action and the corresponding first subspace for the above three types of target actions with different difficulty degrees. Similarly, the video generating module 904 may generate three videos with different difficulty degrees for the above target actions with different difficulty degrees.

In various embodiments, new action videos may further be generated in real-time based on temporary occurrences. Based on the various embodiments, the collecting module 901 may further include collecting movable object information, and the movable object information is feature information describing occupation of the three-dimensional space by the movable object. For example, when the user body information and the space environment information are collected and the space environment image is generated, the movable object information may also be collected if the movable object enters the space environment of the user. The space determining module 902 determines a first subspace required for the next action of the user according to the user body information, the space environment information and the standard action information, and may further include: calculating, in response to the movable object information in the space environment being collected, a movement trajectory of the user performing the standard action, and calculating a movement trajectory of the movable object; determining whether the movement trajectory of the user performing the standard action overlaps with the movement trajectory of the movable object, and deleting, in response to there is the overlap, a candidate subspace corresponding to the overlap when selecting a subspace satisfying the first preset condition. Since the candidate subspace where the collision may occur is selected out, the actions generated by the video generating module 904 will not fall in the subspace where the collision may occur. Similarly, the user follows the demonstration of an instructor in the corresponding video to complete the action, avoiding the next action of the user being involved in a collision with the movable object. The apparatus embodiment of the present application may collect a movable object temporarily entering the space in real-time, and automatically generate an action to avoid the collision with the movement trajectory of the movable object, without the need of the user's attention on the movable object, which improves the user experience.

In various embodiments, the method according to various embodiments may also be applied to VR games. Based on various embodiments, the space determining module 902 is configured to determine a first subspace required for the next action of the user according to the user body information, the space environment information and the standard action information, and may further include: calculating a movement trajectory of the user performing the standard action, determining whether the movement trajectory of the user performing the standard action collision with the space environment and an object in the space environment and if there is a collision, deleting a candidate subspace corresponding to the collision when a subspace satisfying the first preset condition is selected. Since the candidate subspace where the collision may occur is selected out, the actions generated by the video generating module 904 will not fall in the subspace where the collision may occur. Similarly, the user completing the action as directed by the game may avoid the collision of the next action of the user with the space environment and an object in the space environment. The apparatus embodiment of the present application may predict an obstacle existing in a real space environment of a user in a VR game, and automatically generate an action for avoiding the obstacle, without the need of the user's attention, which improves the user experience.

Various embodiments may provide a computer-readable medium storing instructions that, when executed by a processor, may perform steps in the method for video generation as described above. In practical applications, the computer-readable medium may be embodied in the device/apparatus/system described in various embodiments above, or may be separate and not incorporated into the device/apparatus/system. The computer-readable storage medium carries one or more programs that, when executed, implement the methods for video generation described in various embodiments above. According to various embodiments, the computer-readable storage medium may be a non-volatile computer-readable storage medium, for example, may include, but is not limited to a portable computer diskette, hard disk, random-access memory (RAM), read-only memory (ROM), erasable programmable read-only memory (EPROM or flash memory), portable compact disk read-only memory (CD-ROM), optical storage device, magnetic storage device, or any suitable combination of the above, which is not intended to limit the scope of protection. In the various embodiments, a computer-readable storage medium may be any tangible medium that contains or stores a program that can be used by or in connection with an instruction execution system, apparatus, or device.

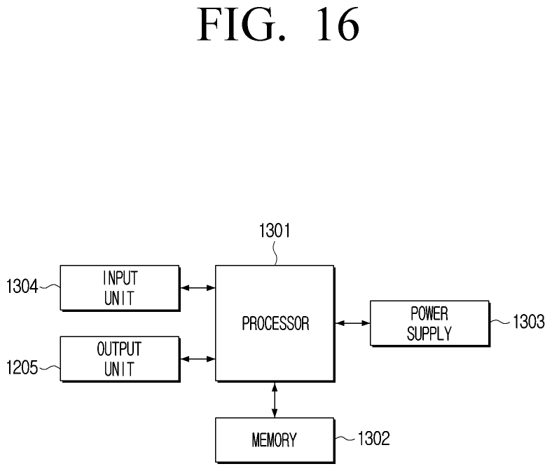

FIG. 16, is a block diagram illustrating an example configuration of an electronic device according to various embodiments.

The electronic device may include a processor (e.g., including processing circuitry) 1301 of one or more processing cores, a memory 1302 of one or more computer-readable storage media, and a computer program stored on the memory and executable on the processor. The method for video generation described above may be implemented when executing programs of the memory 1302.

The electronic device may further include components such as a power supply 1303, an input unit (e.g., including input circuitry) 1304, and an output unit (e.g., including output circuitry) 1305. It will be understood by those skilled in the art that the structure of the electronic device shown in FIG. 16 is not limited to the electronic device and may include more or fewer components than shown, or some components may be combined, or a different arrangement of components.

The processor 1301 may include various processing circuitry and is the control center of the electronic device, connecting various portions of the entire electronic device with various interfaces and lines, performing various functions of the server, and processing data by running or executing software programs and/or modules stored in the memory 1302 and calling data stored in the memory 1302, to monitor the electronic device as a whole. The processor 1301 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 1302 can be configured to store software programs and modules, that is, the above computer-readable storage media. The processor 1301 may perform various functional applications and data processing by running software programs and modules stored in the memory 1302. The memory 1302 may include a storage program area and a storage data area; the storage program area may store an operating system, an application program required by at least one function, and the like; the storage data area may store data created according to the use of the server, and the like. In addition, the memory 1302 may include a high-speed random-access memory, and may also include a non-volatile memory, such as at least one magnetic disk storage device, a flash device, or other volatile solid-state storage device. Accordingly, the memory 1302 may also include a memory controller (not shown) to provide access to the memory 1302 by the processor 1301.

The electronic device also includes a power supply 1303 for powering the various components, which may be logically connected to the processor 1301 through a power management system, such that charging, discharging, and power consumption management functions are managed through the power management system. The power supply 1303 may also include any one or more of a direct or alternating current power source, a recharging system, a power failure detection circuit, a power converter or inverter, a power status indicator, and the like.

The electronic device may further include an input unit 1304. The input unit 1304 may include various input circuitry and be configured to receive input numeric or character information and to generate keyboard, mouse, joystick, optical signal input related to user settings and function control.

The electronic device may further include an output unit 1305. The output unit 1305 may include various output circuitry and be configured to display information input by or provided to the user as well as various graphical user interfaces that may include graphics, text, icons, video, and any combination thereof.

Embodiments of the disclosure may further provide a computer program product including computer instructions that, when executed by a processor, perform the method according to any embodiment.

The flowcharts and block diagrams in the drawings of the disclosure illustrate various examples of the architecture, functionality, and operation of possible implementations of systems, methods, and computer program products according to various embodiments disclosed in the present application. In this regard, each block in the flowcharts or block diagrams may represent a module, program segment, or portion of code, which includes one or more executable instructions for implementing the specified logical functions. It should also be noted that in some implementations, the functions noted in the blocks may occur out of the order noted in the various drawings. For example, two connectively represented blocks may be executed substantially in parallel, or they may sometimes be executed in the reverse order, depending on the functionality involved. It will also be noted that each block in the block diagrams or flowcharts, and combinations of blocks in the block diagrams or flowcharts, may be implemented by special hardware-based systems which perform the specified functions or operations, or by combinations of special hardware and computer instructions.

It will be appreciated by one skilled in the art that various combinations of features recited in the various embodiments and/or claims of the present disclosure may be made even if such combinations are not expressly recited in the present application. For example, various combinations of features recited in the various embodiments and/or claims of the present application may be made without departing from the spirit and teachings of the present application, and all such combinations fall within the scope disclosed by the present application.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for video generation, comprising:
collecting user body information and space environment information and generating a space environment image, the user body information including feature information describing occupation of a three-dimensional space by each body part of the user, and the space environment information including feature information describing a space environment and occupation of the three-dimensional space by an object in the space environment;
generating action prompt information according to the user body information, the space environment information and standard action information, the standard action information including feature information about a standard action that is not subject to the user body information and the space environment information, and the action prompt information including description information about a next action of the user; and
generating a video corresponding to the action prompt information according to the space environment image, a video key frame corresponding to the standard action information and the action prompt information.

2. The method according to claim 1, wherein between collecting the user body information and the space environment information and generating the space environment image and generating the action prompt information according to the user body information, the space environment information and the standard action information, the method further comprises:
determining a first subspace required for the next action of the user according to the user body information, the space environment information, and the standard action information; and
the generating the action prompt information according to the user body information, the space environment information and the standard action information comprises: generating the action prompt information according to the user body information, the first subspace and the standard action information.

3. The method according to claim 2, wherein the determining the first subspace required for the next action of the user according to the user body information, the space environment information and the standard action information comprises:
calculating, according to the user body information and the standard action information, the amount of space required by the user to perform the standard action;
dividing, according to the amount of space required by the user, the space environment to obtain candidate subspaces; and
selecting, from the candidate subspaces according to a first specified condition, a subspace satisfying the first specified condition as the first subspace.

4. The method according to claim 2, wherein the generating the action prompt information according to the user body information, the first subspace and the standard action information comprises:
determining a spatial position relationship between respective related body parts of the user and the first subspace according to the user body information, the first subspace and the standard action information;
combining the respective related body parts of the user and the first subspace to generate candidate actions;
selecting a target action from the candidate actions according to a second specified condition, the target action being the next action to be completed by the user in the first subspace; and
generating the action prompt information according to the spatial position relationship between the respective related body parts of the user and the first subspace in the target action.

5. The method according to claim 4, wherein
in response to a body part of the user requiring assistance of an object in the space environment:
the first subspace includes a space environment where the first subspace is located and comprises a space of the object providing the assistance;
the determining the spatial position relationship between respective related body parts of the user and the first subspace according to the user body information, the first subspace and the standard action information comprises: determining a spatial position relationship between the related body part and the object providing the assistance in the first subspace in response to predicting that the user performs the standard action in the first subspace; and
the generating the action prompt information according to the spatial position relationship between the respective related body parts of the user and the first subspace in the target action comprises: generating the action prompt information according to the spatial position relationship between the related body part of the user and the object in the first subspace in the target action.

6. The method according to claim 4, wherein
in response to a body part of the user requiring avoiding an object in the space environment:
the first subspace includes a space environment where the first subspace is located and does not comprise a space of the object to be avoided;
the determining the spatial position relationship between respective related body parts of the user and the first subspace according to the user body information, the first subspace and the standard action information comprises: determining a spatial position of the related body part of the user in the first subspace in response to predicting that the user performs the standard action in the first subspace; and
the generating the action prompt information according to the spatial position relationship between the respective related body parts and the first subspace in the target action comprises: generating the action prompt information according to the spatial position of the related body part in the first subspace in the target action.

7. The method according to claim 2, wherein
an amount of the first subspaces is N, and N is a natural number greater than one;
the generating the action prompt information according to the user body information, the first subspace and the standard action information comprises: generating N pieces of action prompt information with different difficulty degrees for N first subspaces according to the user body information, the first subspace and the standard action information,
the video corresponding to the action prompt information comprising videos respectively corresponding to the N pieces of action prompt information with different difficulty degrees; and
after the generating the video corresponding to the action prompt information according to the space environment image, the video key frame corresponding to the standard action information and the action prompt information, the method further comprises:
recommending one of the videos respectively corresponding to the N pieces of action prompt information with different difficulty degrees to the user according to acquired user body conditions, the user body conditions being determined by the user body information and historical user operation information acquired in advance.

8. The method according to claim 3, further comprising:
collecting movable object information in the space environment, the movable object information including feature information describing occupation of the three-dimensional space by a movable object; and
calculating, in response to the movable object information in the space environment being collected, a movement trajectory of the user performing the standard action, and calculating a movement trajectory of the movable object; determining whether the movement trajectory of the user performing the standard action overlaps with the movement trajectory of the movable object, and deleting, in response to there being an overlap, a candidate subspace corresponding to the overlap based on selecting a subspace satisfying the first specified condition.

9. The method according to claim 1, wherein the generating the video corresponding to the action prompt information according to the space environment image, a video key frame corresponding to the standard action information and the action prompt information comprises:
calculating a spatial attentional feature according to the space environment image;
calculating a temporal attentional feature according to the video key frame corresponding to the standard action; and
inputting the spatial attentional feature, the temporal attentional feature, and the action prompt information into a trained deep learning network model, and generating the video corresponding to the action prompt information according to the space environment image and the video key frame corresponding to the standard action.

10. The method according to claim 9, wherein the inputting the spatial attentional feature, the temporal attentional feature, and the action prompt information into the trained deep learning network model, and generating the video corresponding to the action prompt information according to the space environment image and the video key frame corresponding to the standard action comprises:
inputting the spatial attentional feature, the temporal attentional feature, and the action prompt information into the trained deep learning network model, and generating a video key frame corresponding to the action prompt information according to the space environment image and the video key frame corresponding to the standard action; and
inserting the video key frame corresponding to the action prompt information into the video corresponding to the standard action information to generate the video corresponding to the action prompt information.

11. The method according to claim 8, wherein
the spatial attentional feature is calculated, according to the space environment image, using a first parameter feature; the temporal attentional feature is calculated, according to the video key frame corresponding to the standard action, using the first parameter feature, the calculations of the spatial attentional feature and the temporal attentional feature comprise feature sharing.

12. An apparatus for video generation, comprising:
a collecting module comprising circuitry, configured to collect user body information and space environment information and generate a space environment image, the user body information including feature information describing occupation of a three-dimensional space by each body part of the user, and the space environment information including feature information describing a space environment and occupation of the three-dimensional space by an object in the space environment;
an action prompt information determining module comprising circuitry, configured to generate action prompt information according to the user body information, the space environment information and standard action information, the standard action information including feature information about a standard action that is not subject to the user body information and the space environment information, and the action prompt information including description information about a next action of the user; and
a video generating module comprising circuitry, configured to generate a video corresponding to the action prompt information according to the space environment image, a video key frame corresponding to the standard action information and the action prompt information.

13. The apparatus according to claim 12, further comprising:
a space determining module comprising circuitry, configured to determine a first subspace required for the next action of the user according to the user body information, the space environment information, and the standard action information; and
the generating the action prompt information according to the user body information, the space environment information and standard action information by the action prompt information determining module comprises: generating the action prompt information according to the user body information, the first subspace and the standard action information.

14. The apparatus according to claim 13, wherein the space determining module comprises:
a user required space calculating module comprising circuitry, configured to calculate, according to the user body information and the standard action information, an amount of space required by the user to perform the standard action;
a candidate subspace determining module comprising circuitry, configured to divide, according to the amount of space required by the user, the space environment to obtain candidate subspaces; and
a first subspace determining module, configured to select, according to a first specified condition, a subspace satisfying the first specified condition from the candidate subspaces as the first subspace.

15. A non-transitory computer-readable storage medium storing computer instructions which, when executed by at least one processor, comprising processing circuitry, individually causing an electronic device to perform a method for video generation, the method comprising:
collecting user body information and space environment information and generating a space environment image, the user body information including feature information describing occupation of a three-dimensional space by each body part of the user, and the space environment information including feature information describing a space environment and occupation of the three-dimensional space by an object in the space environment;
generating action prompt information according to the user body information, the space environment information and standard action information, the standard action information including feature information about a standard action that is not subject to the user body information and the space environment information, and the action prompt information including description information about a next action of the user; and
generating a video corresponding to the action prompt information according to the space environment image, a video key frame corresponding to the standard action information and the action prompt information.
